(19) United States
(12) Patent Application Publication
(10) Pub. No.: US 2026/0111099 A1
(43) Pub. Date: Apr. 23, 2026

(54) SYSTEM FOR PROVIDING A SINGLE REMOTE-CONTROL FOR AN AUDIO SYSTEM INCLUDING MUTLIPLE AUDIO DEVICES

(71) Applicant: Odeon Inc., Corpus Christi, TX (US)

(72) Inventor: Jason Stoddard, Corpus Christi, TX (US)

(21) Appl. No.: 19/357,748

(22) Filed: Oct. 14, 2025

Related U.S. Application Data
(60) Provisional application No. 63/709,187, filed on Oct. 18, 2024.

(51) Int. Cl. G06F 3/0482; G06F 3/16; H04R 29/00

(52) U.S. Cl. CPC G06F 3/0482; G06F 3/165; H04R 29/008; H04R 2227/005; H04R 2430/01

(57) ABSTRACT

The present disclosure provides a system for controlling an audio system or stack including two or more audio components. The system may provide a user interface for receiving user inputs. The system may also determine and apply parameter and setting data for each individual component of the audio system or stack based at least in part on the user inputs and sensor data from each audio device.

### CROSS-REFERENCE TO RELATED APPLICATION

This application claims priority to U.S. Provisional Application No. 63/709,187 filed on Oct. 18, 2024 and entitled “Novel remote control and UX ecosystem providing multi-product dashboard, inter-system optimization and extensibility for home entertainment systems,” which is incorporated herein by reference in its entirety.

### BACKGROUND

Today, remote controls are common in audio and/or audio-visual systems, providing the ability to use a product from a comfortable listening or viewing position. However, conventional remote controls have significant drawbacks. The conventional remote controls are usually designed to control a single product, while audio and audio-visual systems typically consist of multiple devices operating in tandem. Accordingly, users typical to have a variety of different controls for one system, which causes confusion.

In some cases, universal remote controls do exist, but the conventional universal remotes have issues due to different standards and often a single universal remote may not be able to accommodate all products in an audio and/or audio-visual system. In addition, programming a universal control is frequently cumbersome, and operation of the resulting complex single remote can be frustrating for a user. Therefore, the need exists for a remote control system designed to work seamlessly with multiple products in multiple systems and to provide real-time feedback on overall system health and operating conditions to improve the user experience.

### BRIEF DESCRIPTION OF FIGURES

The detailed description is described with reference to the accompanying figures. In the figures, the left-most digit(s) of a reference number identifies the figure in which the reference number first appears. The use of the same reference numbers in different figures indicates similar or identical components or features.

FIG. 1 is an example block diagram of a remote-control system for controlling and monitoring audio and/or audio-visual devices, according to some implementations.

FIG. 2 is an example block diagram of a remote-control system for parameter determination and monitoring in audio and/or audio-visual systems, according to some implementations.

FIG. 3 is a flow diagram illustrating an example process associated with remote control and monitoring of audio and/or audio-visual systems, according to some implementations.

FIG. 4 is a flow diagram illustrating an example process associated with adding and integrating new components into existing audio and/or audio-visual systems, according to some implementations.

FIG. 5 is an example system that may implement the techniques described herein according to some implementations.

FIG. 6 is an example user equipment that may implement the techniques described herein according to some implementations.

FIG. 7 is an example audio system or stack comprising multiple audio devices configured to operate in tandem to provide a unified audio experience within a physical environment, according to some implementations.

FIG. 8 is an example user interface displayed on user equipment for controlling and monitoring an audio system or stack, according to some implementations.

FIG. 9 is an example user interface displayed on user equipment showing detailed audio system control elements and operational monitoring capabilities, according to some implementations.

FIG. 10 is an example user interface displayed on user equipment showing an input selection interface for one or more audio devices of an associated audio system or stack, according to some implementations.

FIG. 11 is an example user interface displayed on user equipment showing volume control functionality with operational limit indicators, according to some implementations.

FIG. 12 is an example user interface displayed on user equipment showing gain selection controls for audio system operation, according to some implementations.

FIG. 13 is an example user interface displayed on user equipment showing volume control functionality with enhanced operational limit or threshold visualization, according to some implementations.

FIG. 14 is another example user interface displayed on user equipment showing volume control functionality with operational limit visualization and current volume level indication, according to some implementations.

FIG. 15 is an example user interface displayed on user equipment showing individual device control interfaces for multiple audio components within an audio system, according to some implementations.

FIG. 16 is an example user interface displayed on user equipment showing audio control settings with unified audio system balance adjustment capabilities for one or more audio devices of the audio system, according to some implementations.

FIG. 17 is another example user interface displayed on user equipment showing audio control settings with device-specific balance adjustment capabilities, according to some implementations.

FIG. 18 is an example user interface displayed on user equipment showing multiple display interfaces with equalizer curve visualization for an audio system including one or more audio devices, according to some implementations.

FIG. 19 is an example user interface displayed on user equipment showing various warning notifications and alert messages for the remote-control system, according to some implementations.

FIG. 20 is an example user interface displayed on user equipment showing amperage monitoring and control capabilities for audio devices within an audio system, according to some implementations.

FIG. 21 is an example user interface displayed on user equipment showing dual interface configurations for comprehensive audio system monitoring and control, according to some implementations.

FIG. 22 is an example user interface displayed on user equipment showing multiple audio systems or stacks controlled by the remote-control system, according to some implementations.

FIG. 23 is an example user interface displayed on user equipment showing enhanced monitoring and warning capabilities for audio system operation, according to some implementations.

FIG. 24 is an example user interface display displayed on user equipment showing current monitoring and control capabilities with multiple operational indicators for multiple audio devices of an audio system or stack, according to some implementations.

FIG. 25 is an example user interface display displayed on user equipment showing system profiling and compatibility testing capabilities for audio devices within an audio system, according to some implementations.

FIG. 26 is an example user interface display displayed on user equipment showing example warning or alert messages that may be generated by a remote-control system in response to operating the audio system or stack, according to some implementations.

FIG. 27 is an example user interface display displayed on user equipment showing parametric equalization control capabilities for audio system operation, according to some implementations.

FIG. 28 is an example user interface display displayed on user equipment showing feature purchase options for audio system or stack, according to some implementations.

### DETAILED DESCRIPTION

Discussed herein is a remote-control system for use with an audio and/or audio-visual system comprising of multiple devices, such as is common in a home audio and/or audio-visual system. In some cases, the remote-control system may provide a graphical user interface for a user to control via one or more integrated control inputs settings associated with one or more devices of the audio and/or audio-visual system. In some cases, the remote-control system may be a downloadable application hosted by user equipment (e.g., smart phone, tablet, computer, and/or the like) configured to communicate with a cloud-based service to provide control of multiple devices of the user's audio and/or audio-visual system. In some cases, the downloadable application may be configured to communicatively couple (e.g., wirelessly couple, such as via Bluetooth, home Wi-Fi, and/or the like) to the one or more devices of the audio and/or audio-visual system, such that the downloadable application may receive operational data associated with each individual device of the system during operations.

In some examples, the remote-control system may receive internal sensor data (e.g., current, voltage, temperature, volume settings, system faults, class A bias data, power data, and/or the like) from each of the devices to determine operational settings and/or limits associated with the combination of or set of devices associated with the audio and/or audio-visual system. For instance, the remote-control system may determine from the combined and or individual sensor data received from individual devices a volume maximum or limit (e.g., a red line) associated with the full audio and/or audio-visual system. In some cases, the volume limit or other settings for the audio and/or audio-visual system may be determined for extended or infinite play of the audio system. In these cases, the remote-control system may determine the audio settings at a level at which the audio and/or audio-visual system may operate indefinitely (e.g., no devices of the audio and/or audio-visual system overheat or experience other issues). In some examples, the audio settings may be determined to maintain the audio and/or audio-visual system in class A operational category.

In some implementations, the remote-control system may include multiple limits, such as an absolute limit (e.g., an overheating limit or the like), an endless play limit or sustainable play limit, a shorter duration (e.g., 1 hour, 2 hour, 3 hours, and/or the like) limit, a warning limit (e.g., some aspect of the audio quality may be reduced but the user may proceed at the user's discretion), as well as other limits. In this implementation, each of the limits may be shown in different colors, styles, or other visual indicators on the display of the user device or equipment hosing the remote-control application.

In some cases, the remote-control system may receive third-party data associated with devices added to the audio and/or audio-visual system from third-party systems. For example, the remote-control system may access data sheets, online content, and/or request data associated with the operations from manufacturers of each device. In these cases, the remote-control system may utilize the third-party data to determine settings and/or parameters for the user's audio and/or audio-visual system.

In some implementations, the remote-control system may cause each device added to the system to perform a test or initialization session in which the remote-control system captures data associated with the operation of the device with respect to the other devices of the audio and/or audio-visual system. For example, if the user adds a new speaker or amplifier to the audio and/or audio-visual system, the remote-control system may receive internal sensor data from the newly added device, while capturing audio via one or more microphones (such as provided by a known or pre-existing device of the audio and/or audio-visual system) to determine a sound quality at various different settings of the newly added device. In these cases, the remote-control system may utilize the test or initialization data to determine settings and/or parameters for the user's audio and/or audio-visual system.

In some examples, the remote-control system may provide a suitability rating or the like to the newly added device after the performing of the initialization and/or after a period of operation and/or based on known metrics of the audio and/or audio-visual system and/or the third-party data. For example, if two devices, such as an amplifier and a speaker, are unsuited for each other (e.g., the amplifier is under powered for the speaker) the system may rate the suitability lower than if the amplifier is fully capable to support the speaker at one or more maximum settings.

In some examples, the remote-control system may allow for adjustment of various settings and/or parameters of the audio and/or audio-visual system, such volume control, tone controls or equalization, digital filtering, and/or the like. The remote-control system may also allow for multiple systems in multiple physical environments (e.g., multiple rooms of the home, such as bedroom, living room, kitchen, and/or the like) to be controlled individually or in combination. For instance, the remote-control system may allow for a user to set audio controls for the home, an individual room, and/or the like and the remote-control system may configure the devices within each physical environment to provide for uniform audio environment at the home. In other examples, the remote-control system may allow for different settings to be configured concurrently for different physical environments, such as a quieter or softer audio experience in the kitchen than in the outdoor pool area of a home.

In some implementations, the remote-control system may allow for users to have one or more different preprogramed audio and/or audio-visual settings, such that the user may easily transition from one setting to another, such as via a single selection that changes the settings on multiple devices of the audio and/or audio-visual system. In some cases, the remote-control system may allow for multiple users (e.g., a first user, a second user, a third user, and/or the like) to have one or more preprogramed audio and/or audio-visual settings that differ from each other.

In some cases, machine learning models may receive sensor data, third-party data, initialization data, and/or the like and utilize the input data to output various settings and control combinations for the user. For example, the machine learning models may determine the limits, combination of parameters or settings for optimal audio output of the system given the added devices, and/or the like. In some cases, the machine learning models may be trained on various types of setting, combination, and audio data. In some cases, the machine learning models may be self-training, e.g., the models train based on data collected during operation within the specific physical environment and according to the acoustical properties of the specific physical environment in which each device is located. In this manner, the remote-control system may tailor or tune the settings and parameters of the audio devices for the custom acoustical properties of the associated environment as well as the properties of the combined devices.

As described herein, the machine learning models may be generated using various machine learning techniques. For example, the models may be generated using one or more neural network(s), large language models (LLMs), or AI agents. A neural network or LLM may be a biologically inspired algorithm or technique which passes input data (e.g., image and sensor data captured by the IoT (Internet of Things) computing devices) through a series of connected layers to produce an output or learned inference. Each layer in a neural network can also comprise another neural network or can comprise any number of layers (whether convolutional or not). As can be understood in the context of this disclosure, a neural network can utilize machine learning, which can refer to a broad class of such techniques in which an output is generated based on learned parameters.

As an illustrative example, one or more neural network(s) may generate any number of learned inferences or heads from the captured sensor and/or image data. In some cases, the neural network may be a trained network architecture that is end-to-end. In one example, the machine learned models may include segmenting and/or classifying extracted deep convolutional features of the sensor and/or image data into semantic data. In some cases, appropriate truth outputs of the model in the form of semantic per-pixel classifications (e.g., vehicle identifier, container identifier, driver identifier, and the like). In some cases, the neural networks, deep learning, LLM, AI agents, as discussed herein may be trained using a self-supervised learning technique and/or supervised learning technique in which label input data or training data associated with logistics operations, warehouse operations, manufacturing operations, and/or the like may be used for training the outputs.

Although discussed in the context of neural networks, any type of machine learning can be used consistent with this disclosure. For example, machine learning algorithms can include, but are not limited to, regression algorithms (e.g., ordinary least squares regression (OLSR), linear regression, logistic regression, stepwise regression, multivariate adaptive regression splines (MARS), locally estimated scatterplot smoothing (LOESS)), instance-based algorithms (e.g., ridge regression, least absolute shrinkage and selection operator (LASSO), elastic net, least-angle regression (LARS)), decisions tree algorithms (e.g., classification and regression tree (CART), iterative dichotomiser 3 (ID3), Chi-squared automatic interaction detection (CHAID), decision stump, conditional decision trees), Bayesian algorithms (e.g., naïve Bayes, Gaussian naïve Bayes, multinomial naïve Bayes, average one-dependence estimators (AODE), Bayesian belief network (BNN), Bayesian networks), clustering algorithms (e.g., k-means, k-medians, expectation maximization (EM), hierarchical clustering), association rule learning algorithms (e.g., perceptron, back-propagation, hopfield network, Radial Basis Function Network (RBFN)), deep learning algorithms (e.g., Deep Boltzmann Machine (DBM), Deep Belief Networks (DBN), Convolutional Neural Network (CNN), Stacked Auto-Encoders), Dimensionality Reduction Algorithms (e.g., Principal Component Analysis (PCA), Principal Component Regression (PCR), Partial Least Squares Regression (PLSR), Sammon Mapping, Multidimensional Scaling (MDS), Projection Pursuit, Linear Discriminant Analysis (LDA), Mixture Discriminant Analysis (MDA), Quadratic Discriminant Analysis (QDA), Flexible Discriminant Analysis (FDA)), Ensemble Algorithms (e.g., Boosting, Bootstrapped Aggregation (Bagging), AdaBoost, Stacked Generalization (blending), Gradient Boosting Machines (GBM), Gradient Boosted Regression Trees (GBRT), Random Forest), SVM (support vector machine), supervised learning, unsupervised learning, semi-supervised learning, etc. Additional examples of architectures include neural networks such as ResNet50, ResNet101, VGG, DenseNet, PointNet, and the like. In some cases, the system may also apply Gaussian blurs, Bayes Functions, color analyzing or processing techniques and/or a combination thereof.

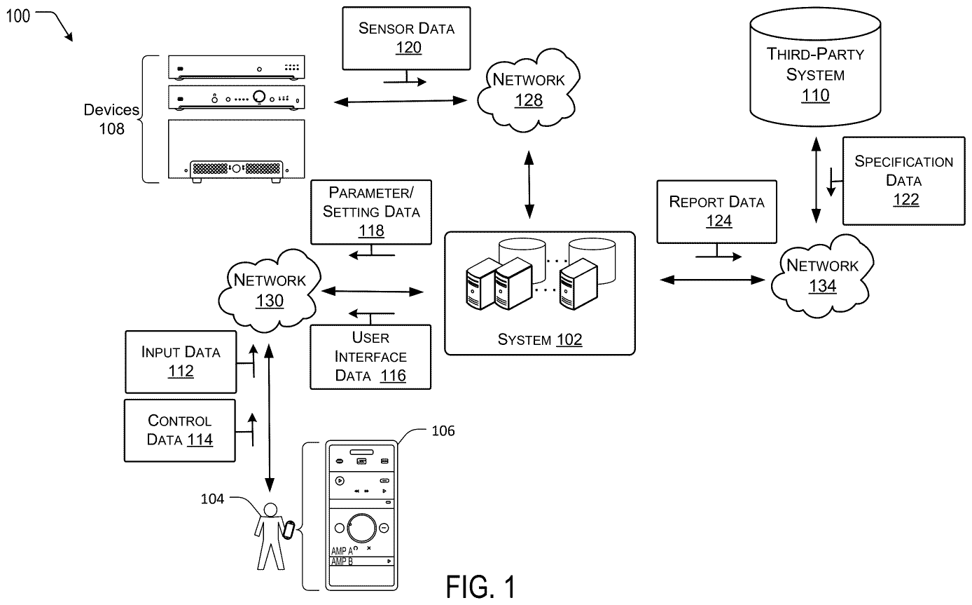

FIG. 1 is an example block diagram of a remote-control system 100 for controlling and monitoring audio and/or audio-visual devices, according to some implementations. In the current example, a cloud-based remote control system 102 may be configured to communicate with a user 104 through a user interface and application hosted on user equipment 106 (e.g., a smartphone, tablet, computer, and/or the like) to provide control and monitoring capabilities for one or more audio device(s) 108 working in tandem (e.g., as a stack of devices to provide a single audio experience within a physical environment). As discussed above, the user equipment 106 may host a downloadable application configured to interface with the cloud-based remote control system 102. The user equipment 106 may be configured to communicatively couple wirelessly to the audio device(s) 108, such as via Bluetooth, home Wi-Fi, and/or similar wireless communication protocols.

In the current example, the cloud-based remote control system 102 may be configured to receive sensor data 120 from the audio device(s) 108 and device specification data 122 from a third-party system 110 (e.g., a manufacturer of each individual device). In this example, the cloud-based remote control system 102 may process the sensor data 120 to determine one or more operational parameters associated with each audio device as the device operates within the audio and/or audio-visual system, generating parameter/setting data 118 associated with each device based on combined operational conditions and capabilities. In some cases, the cloud-based remote control system 102 may analyze each device's performance characteristics and determine operational limits (e.g., volume limits, thermal limits, and/or the like) associated with each device as each device operates within the combined system.

The cloud-based remote control system 102 may also process the device specification data 122 received from the third-party system 110. For example, the cloud-based remote control system 102 may process the device specification data 122 to determine compatibility and optimal settings associated with each device when integrated with other devices within the audio and/or audio-visual system. In some cases, the cloud-based remote control system 102 may confirm or verify the operational parameters by comparing and/or analyzing the sensor data 120 received from the audio device(s) 108 and the device specification data 122 received from the third-party system 110.

The cloud-based remote control system 102 may also utilize the sensor data 120 and device specification data 122 to generate user interface data 116 and control data 114 for presentation to the user 104 via the application hosted on the user equipment 106. In some cases, the user interface data 116 may include visual indicators, alerts, and control options that may be consumed by the user 104 through various display interfaces on the user equipment 106. In some cases, the display interface may be a touch-enabled display that allows for direct user interaction with the control elements, such as typically used in conjunction with smartphones and tablets.

In some examples, the user interface data 116 may include indicators such as a volume control interface that displays operational limits based on the combined parameters of all devices within the audio and/or audio-visual system. For instance, the user interface may present a volume slider, wheel, or other control element that visually indicates one or more operational thresholds determined from the collective sensor data 120 and device specification data 122 of the connected audio device(s) 108. The volume control interface may display a green zone representing safe operational levels where all devices may operate indefinitely without thermal or performance concerns, a yellow zone indicating caution levels where devices may operate for limited durations (e.g., 1-3 hours), and a red zone representing maximum operational limits beyond which one or more devices may experience overheating or performance degradation.

In some cases, the volume control interface may dynamically adjust these operational zones based on real-time sensor data 120 received from each audio device within the audio and/or audio-visual system. For example, if the cloud-based remote control system 102 determines that an amplifier is operating at elevated temperatures while a connected speaker remains within normal thermal ranges, the volume limit zones may be adjusted to reflect the thermal constraints of the amplifier as the limiting factor for the combined system. The user interface may also provide textual or graphical indicators showing which specific device is currently limiting the overall system performance, allowing the user 104 to understand the operational constraints of their particular audio and/or audio-visual configuration.

In some implementations, the volume control interface may include additional visual elements such as real-time power consumption indicators, thermal status icons for individual devices, or compatibility ratings between connected components. The interface may also allow the user 104 to override certain operational limits with appropriate warnings, providing flexibility while maintaining awareness of potential risks to the audio device(s) 108 within the system.

In some cases, the cloud-based remote control system 102 may enhance the user interface data 116 with report data 124 associated with the performance and status of the audio device(s) 108 and/or associated with the overall audio and/or audio-visual system. For example, the cloud-based remote control system 102 may determine and display device identifiers, operational status, various operational metrics (e.g., temperature readings, power consumption, volume levels, and/or the like), indicators for system health and performance, and/or similar information. In some cases, the cloud-based remote control system 102 may provide the report data 124 to the third-party system 110 such as to inform the third-party system 110 as to real-time operational data with various other third-party devices.

In the current example, the control data 114, user interface data 116, parameter/setting data 118, sensor data 120, device specification data 122, and report data 124 may be transmitted to the cloud-based remote control system 102 using networks, generally indicated by 128-134. The networks 128-134 may be any type of network that facilitates communication between one or more systems and may include one or more cellular networks, radio, WiFi networks, short-range or near-field networks, infrared signals, local area networks, wide area networks, the internet, and so forth. In the current example, each network 128-134 is shown as a separate network but it should be understood that two or more of the networks may be combined or the same.

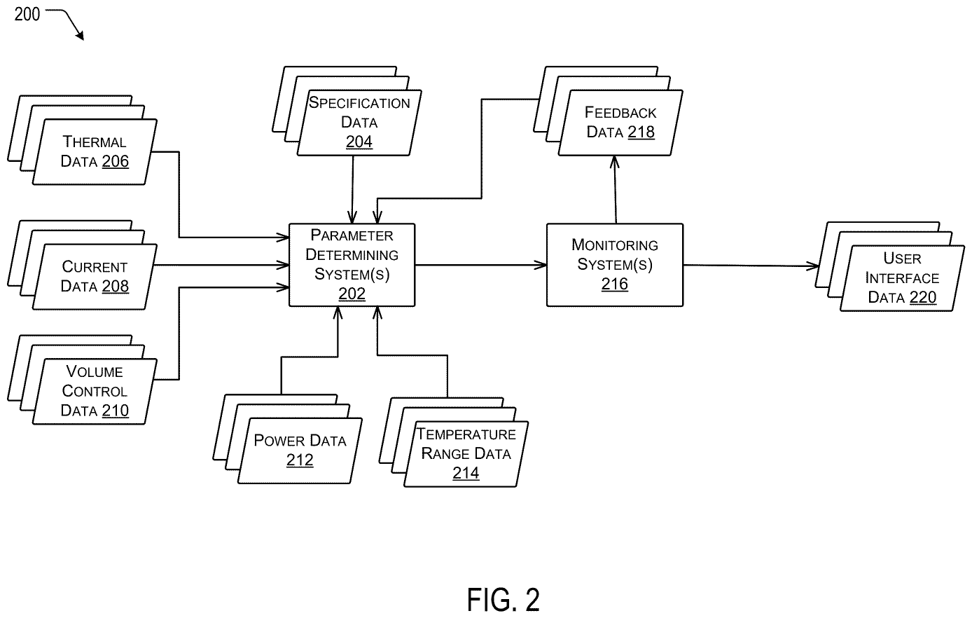

FIG. 2 is an example block diagram of a remote-control system 200 for parameter determination and monitoring in audio and/or audio-visual systems, according to some implementations. In the current example, the remote-control system 200 may include a parameter determining system 202 configured to receive and process various types of data to determine operational parameters for connected audio devices. The parameter determining system 202 may be configured to receive specification data 204, which may include manufacturer specifications, device capabilities, and compatibility information for individual audio components within the system.

In some cases, the parameter determining system 202 may receive thermal data 206 from temperature sensors embedded within or associated with the audio devices. The thermal data 206 may include real-time temperature measurements, thermal thresholds, and heat dissipation characteristics that may be used to determine safe operational limits for the audio system. The parameter determining system 202 may also receive current data 208, which may include electrical current measurements, power draw information, and current consumption patterns from the connected audio devices.

The parameter determining system 202 may further receive volume control data 210, which may include audio level settings, gain adjustments, and volume-related parameters from the audio devices. In some implementations, the parameter determining system 202 may process power data 212, which may include power consumption metrics, efficiency ratings, and power delivery characteristics of the audio components. The parameter determining system 202 may also receive temperature range data 214, which may include operational temperature ranges, thermal limits, and temperature-related performance characteristics for each device in the audio system.

In the current example, the remote-control system 200 may include a monitoring system 216 configured to analyze the data processed by the parameter determining system 202 and generate monitoring outputs. The monitoring system 216 may receive processed data from the parameter determining system 202 and generate feedback data 218 based on the analysis of the various input data streams. The feedback data 218 may include system status information, performance metrics, alerts, and recommendations for optimal system operation.

The monitoring system 216 may generate user interface data 220 that may be transmitted to user equipment for display to a user. The user interface data 220 may include visual representations of system status, control interfaces, operational limits, and other information derived from the analysis performed by the parameter determining system 202 and monitoring system 216. In some cases, the user interface data 220 may include real-time updates of system performance, allowing users to monitor and adjust their audio system settings based on current operational conditions.

In some examples, the user interface data 220 may include comparisons or visual indications of current status with respect to various determined thresholds or parameters. For instance, the user interface may display real-time operational metrics alongside predetermined safe operating ranges, allowing users to visualize how closely their audio system is approaching thermal, power, or performance limits. The interface may present comparative displays showing current temperature readings against maximum thermal thresholds for each connected device, or may indicate current power consumption levels relative to recommended operational ranges.

As discussed herein, in some cases, the visual indications may include color-coded status indicators that change dynamically based on proximity to determined thresholds. For example, temperature indicators may display green when devices operate well within safe ranges, transition to yellow as temperatures approach caution levels, and shift to red when nearing maximum operational thresholds. Similarly, power consumption indicators may provide visual feedback comparing current draw against optimal efficiency ranges or maximum power delivery capabilities of connected components.

The user interface data 220 may also include graphical representations such as bar charts, gauges, trend lines, and/or the like that illustrate how current operational parameters relate to various determined limits over time. In some implementations, the interface may display percentage indicators showing how much headroom remains before reaching specific thresholds or may provide numerical comparisons between current settings and recommended operational parameters for extended system longevity.

In some cases, the parameters and thresholds may change or modify during operation as the length of a current operational instance extends. For example, the parameter determining system 202 may dynamically adjust operational limits based on the duration of continuous system operation together with the feedback data 218 and sensor data from the devices of the audio and/or audio-visual system (e.g., thermal data 206, current data 208, power data 212 and/or the like). For instance, in some cases, the thermal thresholds may become more restrictive as devices accumulate heat over extended periods of use. In some implementations, the monitoring system 216 may track the cumulative operational time and gradually reduce maximum volume limits or power thresholds to account for thermal buildup and component stress that occurs during prolonged listening sessions. In some cases, the parameter determining system 202 may utilize time-based algorithms that factor in the duration of current operation when calculating safe operational ranges. In some cases, devices that have been operating for shorter periods may be permitted to operate at higher levels compared to devices that have been running continuously for extended durations. The system may implement sliding thresholds where the green, yellow, and red operational zones shift toward more conservative limits as the operational session progresses, providing additional protection against thermal damage or performance degradation during marathon listening sessions.

In some examples, the parameter determining system 202 may also receive duration data from the user interface of the application as an indication of an estimated period of time the user is planning on continuously operating the audio or audio-visual system. In these examples, the parameter determining system 202 may determine parameters, settings, and/or limits based on the estimated period of time or estimated duration of continuous operation. In this manner, the parameters, settings, and/or limits determined by the system 200 and presented to the user via the user interface of the application hosted on the user equipment may be customized per-session or per-operational period. In some examples, the monitoring system 216 may also consider factors such as ambient temperature changes, device warm-up periods, and thermal cycling effects when modifying parameters during operation.

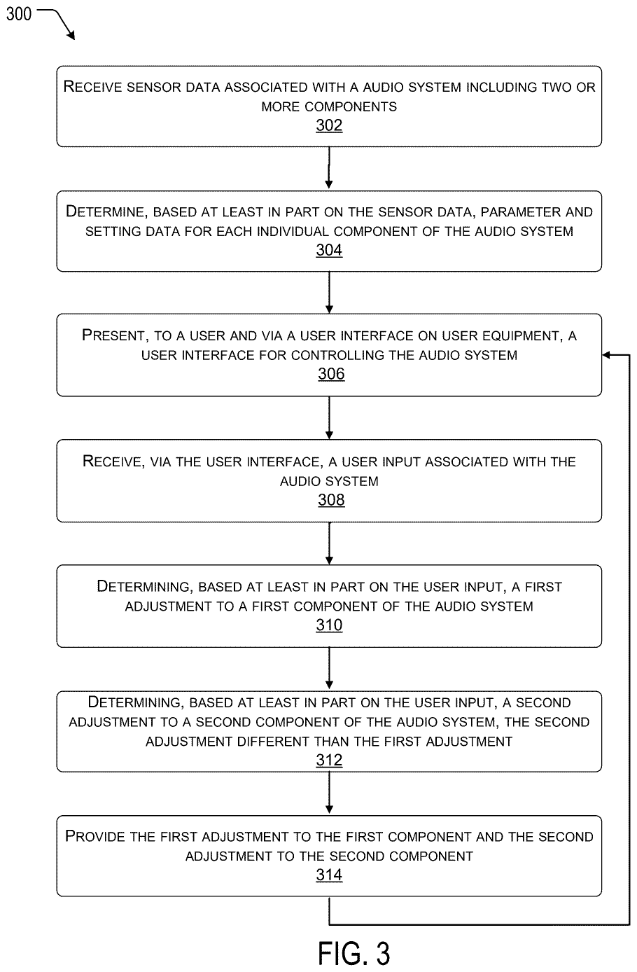

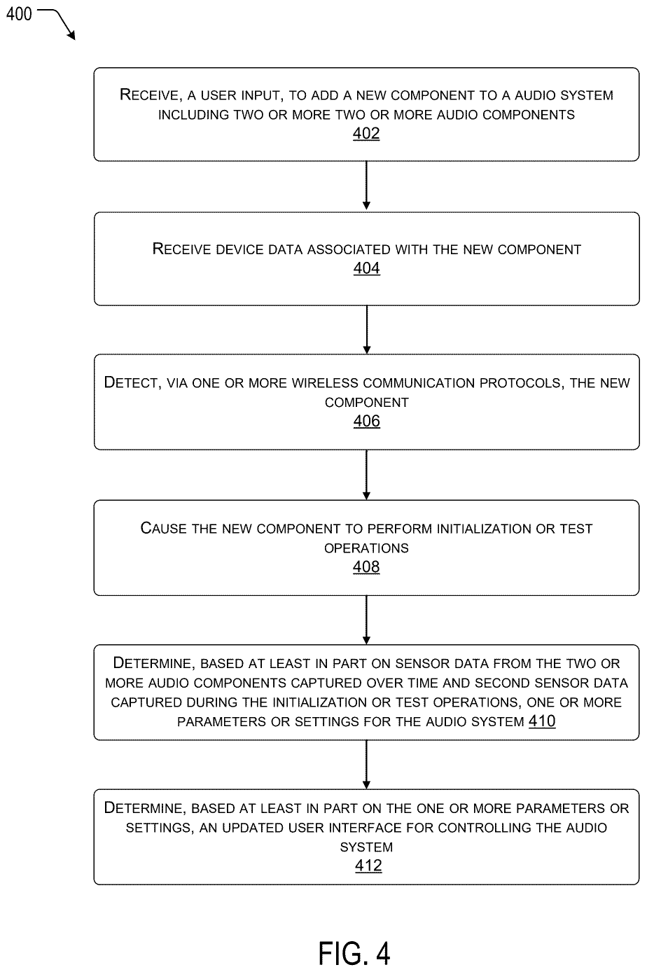

FIGS. 3 and 4 are flow diagrams illustrating example processes associated with the system discussed herein. The processes are illustrated as a collection of blocks in a logical flow diagram, which represent a sequence of operations, some or all of which can be implemented in hardware, software, or a combination thereof. In the context of software, the blocks represent computer-executable instructions stored on one or more computer-readable media that, when executed by one or more processor(s), perform the recited operations. Generally, computer-executable instructions include routines, programs, objects, components, encryption, deciphering, compressing, recording, data structures and the like that perform particular functions or implement particular abstract data types.

The order in which the operations are described should not be construed as a limitation. Any number of the described blocks can be combined in any order and/or in parallel to implement the processes, or alternative processes, and not all of the blocks need be executed. For discussion purposes, the processes herein are described with reference to the frameworks, architectures and environments described in the examples herein, although the processes may be implemented in a wide variety of other frameworks, architectures or environments.

FIG. 3 is a flow diagram illustrating an example process 300 associated with remote control and monitoring of audio and/or audio-visual systems, according to some implementations. As discussed herein, the remote-control system may be configured to provide unified control and monitoring capabilities for multiple audio devices operating in tandem as an audio and/or audio-visual system. The remote-control system may utilize sensor data and device specifications that may, in some cases, utilize cloud-based services to determine operational parameters, monitor system health, and provide real-time feedback to users regarding system performance and operational limits.

At 302, the remote-control system may receive sensor data associated with an audio system including two or more audio components or devices. In some cases, the sensor data may include thermal data, current data, power data, volume control data, and/or other operational metrics from temperature sensors, current sensors, and monitoring circuits embedded within or associated with the audio devices.

At 304, the remote-control system may determine operational parameters based at least in part on the sensor data. For instance, the remote-control system may utilize the sensor data together with device specifications, compatibility information, and performance characteristics to determine safe operational limits, thermal thresholds, and power consumption parameters for the combined audio system.

At 306, the remote-control system may present a user interface for controlling the audio system to a user via user equipment. In some cases, the user interface may include visual representations of the determined operational parameters, control elements for adjusting system settings, and real-time status indicators showing current operational conditions relative to the determined limits. The user interface may display color-coded zones indicating safe operational ranges, caution levels, and maximum thresholds for various system parameters.

At 308, the remote-control system may receive, via the user interface, a user input associated with the audio system. In some implementations, the user input may include volume adjustments, equalization settings, power mode selections, or other control commands intended to modify the operation of one or more components within the audio system. The user input may be received through touch controls, voice commands, gesture inputs, or other interaction methods supported by the user equipment.

At 310, the remote-control system may determine, based at least in part on the user input, a first adjustment to a first component of the audio system. In some cases, the first adjustment may be calculated considering the operational parameters determined for the first component, its current operational state, and its interaction with other components in the system. The first adjustment may include modifications to volume levels, gain settings, power output, or other operational characteristics specific to the first component.

At 312, the remote-control system may determine, based at least in part on the user input, a second adjustment to a second component of the audio system, where the second adjustment is different than the first adjustment. In some implementations, the second adjustment may be tailored to the operational characteristics and current state of the second component, which may differ from those of the first component due to variations in device specifications, thermal conditions, power capabilities, or other factors. The system may calculate different adjustments for each component to achieve optimal overall system performance.

At 314, the remote-control system may provide the first adjustment to the first component and the second adjustment to the second component. In some cases, the adjustments may be transmitted concurrently or sequentially to the respective components through wireless communication protocols, wired connections, or other communication methods. The system may monitor the implementation of the adjustments and verify that each individual component has successfully applied the received settings, potentially providing feedback to the user regarding the status of the adjustment process.

In some cases, the process 300 may return to 306 and present an updated user interface reflecting the adjustments made to the first and second components. In some cases, the updated user interface may display revised operational parameters, modified threshold indicators, and current status information based on the new operational states of the components following the implementation of the adjustments. The updated interface may show how the adjustments have affected the overall system performance, thermal conditions, power consumption, and available operational headroom for continued use.

FIG. 4 is a flow diagram illustrating an example process 400 associated with adding and integrating new components into existing audio and/or audio-visual systems, according to some implementations. As discussed herein, the remote-control system may be configured to detect, initialize, and integrate new audio devices into an existing audio and/or audio-visual system while maintaining optimal performance and compatibility across all connected components. The remote-control system may utilize initialization procedures, compatibility testing, and real-time sensor monitoring to ensure seamless integration of new devices.

At 402, the remote-control system may receive a user input to add a new component to an audio system including two or more audio components. In some cases, the user input may be received through the user interface of the application hosted on user equipment, where the user may select options to add new devices, initiate device discovery modes, or manually specify device information for integration into the existing audio system.

At 404, the remote-control system may receive device data associated with the new component. In some implementations, the device data may include manufacturer specifications, model information, compatibility parameters, operational characteristics, and technical specifications retrieved from third-party systems, device databases, or directly from the new component itself through communication protocols.

At 406, the remote-control system may detect the new component via one or more wireless communication protocols. In some cases, the detection may occur through Bluetooth discovery, Wi-Fi network scanning, infrared communication, or other wireless protocols supported by both the remote-control system and the new component. The system may establish initial communication channels and verify the identity and capabilities of the new component.

At 408, the remote-control system may cause the new component to perform initialization or test operations. In some examples, the initialization operations may include calibration procedures, compatibility tests, performance benchmarking, and integration assessments designed to evaluate how the new component interacts with existing devices in the audio system. The test operations may involve controlled audio playback, sensor data collection, and performance measurement across various operational parameters.

At 410, the remote-control system may determine, based at least in part on sensor data from the two or more audio components captured over time and second sensor data captured during the initialization or test operations, one or more parameters or settings for the audio system. In some implementations, the system may analyze the combined sensor data to establish new operational limits, compatibility ratings, thermal thresholds, and performance parameters that account for the addition of the new component to the existing system configuration.

At 412, the remote-control system may determine, based at least in part on the one or more parameters or settings, an updated user interface for controlling the audio system. In some cases, the updated user interface may reflect the expanded capabilities, modified operational limits, and new control options available with the integrated new component. The interface may display revised threshold indicators, updated system topology, and enhanced control elements that accommodate the functionality provided by the newly added device.

In some cases, the process 400 may continue with ongoing monitoring and optimization of the expanded audio system. The remote-control system may continuously evaluate the performance of the newly integrated component alongside existing devices, making dynamic adjustments to operational parameters as needed to maintain optimal system performance and component longevity.

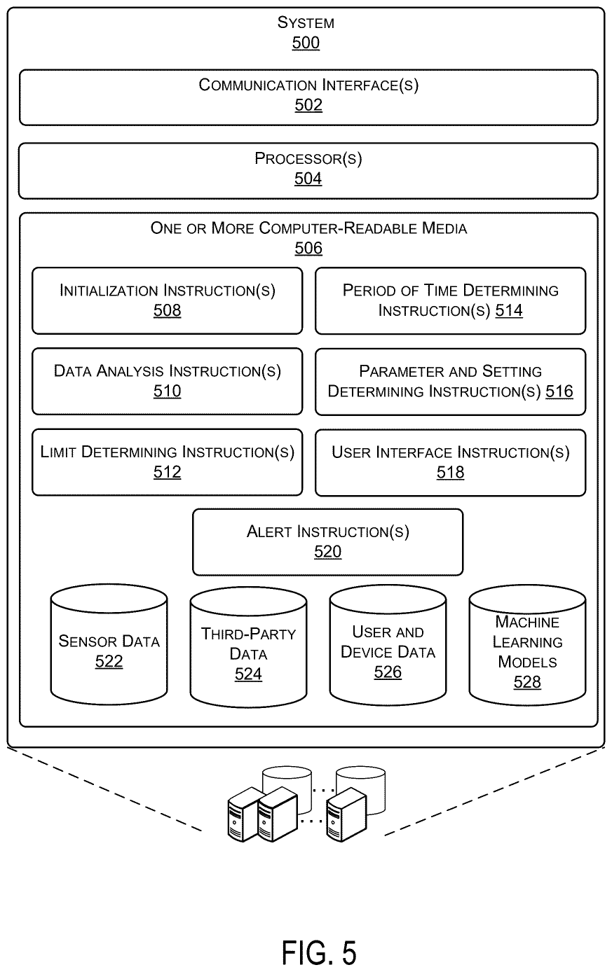

FIG. 5 is an example system 500 that may implement the techniques described herein according to some implementations. For example, the system 500 may include one or more communication interface(s) 502 that enables communication between the system 500 and one or more other local or remote computing device(s) or remote services, such as one or more audio devices, user equipment, third-party systems, and/or cloud-based services. For instance, the communication interface(s) 502 can facilitate communication with audio components, wireless speakers, amplifiers, or distributed audio management platforms. The communications interface(s) 502 may enable Wi-Fi-based communication such as via frequencies defined by the IEEE 802.11 standards, short range wireless frequencies such as Bluetooth, cellular communication (e.g., 2G, 3G, 4G, 4G LTE, 5G, etc.), infrared communication, or any suitable wired or wireless communications protocol that enables the respective computing device to interface with the other computing device(s).

In some implementations, the system 500 may be configured as a cloud-based system that operates in conjunction with one or more applications hosted by user equipment, as discussed herein. The cloud-based configuration may allow the system 500 to provide centralized processing capabilities, data storage, and computational resources that may be accessed by multiple user devices simultaneously. In some cases, the applications hosted on user equipment may serve as client interfaces that communicate with the cloud-based system 500 to receive processed data, control commands, and user interface updates. The cloud-based architecture may enable the system 500 to aggregate sensor data from multiple audio systems across different locations, perform complex analysis using machine learning models (such as large langrage models, artificial intelligence agent, and/or the like), and provide consistent user experiences across various types of user equipment. In some examples, the cloud-based system 500 may maintain user profiles, device configurations, and operational histories that may be synchronized across multiple user devices, allowing users to access their audio system controls and monitoring capabilities from smartphones, tablets, computers, or other connected devices.

The system 500 may include one or more processor(s) 504 and one or more computer-readable media 506. Each of the processors 504 may itself comprise one or more processors or processing cores. The computer-readable media 506 is illustrated as including memory/storage. The computer-readable media 506 may include volatile media (such as random access memory (RAM)) and/or nonvolatile media (such as read only memory (ROM), Flash memory, optical disks, magnetic disks, and so forth). The computer-readable media 506 may include fixed media (e.g., GPU, NPU, RAM, ROM, a fixed hard drive, and so on) as well as removable media (e.g., Flash memory, a removable hard drive, an optical disc, and so forth). The computer-readable media 506 may be configured in a variety of other ways as further described below.

Several modules such as instructions, data stores, and so forth may be stored within the computer-readable media 506 and configured to execute on the processors 504. For example, as illustrated, the computer-readable media 506 stores initialization instruction(s) 508, data analysis instruction(s) 510, limit determining instruction(s) 512, time period determining instruction(s) 514, parameter determining instruction(s) 516, user interface instruction(s) 518, and alert instruction(s) 520, as well as other instructions, such as an operating system. The computer-readable media 506 may also be configured to store data, such as sensor data 522, third party data 524, user device data 526, and one or more machine learning model(s) 528.

The initialization instruction(s) 508 may be configured to perform initialization and test operations on newly added audio components to evaluate compatibility and performance characteristics within existing audio systems based at least in part on device specifications and operational requirements. The initialization instruction(s) 508 may be used to capture sensor data 522 from newly added audio components during initialization and test operations. In some cases, the initialization instruction(s) 508 may coordinate with the newly added components to collect thermal measurements, current consumption data, power levels, and other operational metrics that may be stored as sensor data 522 for subsequent analysis. The captured sensor data 522 may include baseline performance measurements, response characteristics under various test conditions, and compatibility metrics that may be used to determine optimal integration parameters for the newly added component within the existing audio system configuration.

The data analysis instruction(s) 510 may be configured to process sensor data from multiple audio components including thermal measurements, current consumption, power levels, and volume settings to determine operational states and performance metrics for individual devices and combined system configurations. The data analysis instruction(s) 510 may utilize this processed sensor data 522 to determine operational characteristics of each audio device of an audio system. In some cases, the data analysis instruction(s) 510 may analyze thermal patterns, power consumption trends, and performance metrics to establish baseline operational profiles for individual components within the audio system. The instruction(s) may identify device-specific operational ranges, thermal response characteristics, and power efficiency parameters that may be used to optimize system-wide performance and prevent component stress or damage during extended use periods.

The limit determining instruction(s) 512 may be configured to establish operational limits and safety thresholds for audio systems by analyzing device capabilities, thermal constraints, and power consumption patterns to prevent component damage and maintain optimal performance levels. In some implementations, the limit determining instruction(s) 512 may be configured to establish multiple types of operational limits for individual audio components within the system, where different devices may have varying thermal thresholds, power consumption limits, and performance boundaries based on their specific design characteristics and operational capabilities. For example, an amplifier may have different thermal limits compared to a connected speaker, and a digital signal processor may have distinct power consumption thresholds compared to other components in the audio system. In some cases, the system may determine absolute maximum limits for each device, sustainable operation limits for extended use periods, and warning thresholds that indicate approaching operational boundaries.

In some examples, the limit determining instruction(s) 512 may be configured to combine these multiple device-specific limits into unified operational parameters that may be presented through a single user interface element or control mechanism. The system may analyze the various individual limits across all connected components and determine the most restrictive operational boundaries that apply to the combined audio system as a whole. In some cases, this may involve identifying which specific device or component represents the limiting factor for overall system performance at any given operational setting.

In some implementations, the unified limits may be presented to users through a single volume control interface, power level indicator, or operational status display that reflects the combined constraints of all connected devices. For instance, the system may present a single volume slider that incorporates thermal limits from an amplifier, power handling limits from speakers, and processing limits from digital components, where the maximum allowable setting represents the most restrictive limit among all connected devices. In some cases, the user interface may display color-coded zones or visual indicators that show safe operational ranges, caution levels, and maximum thresholds based on the combined analysis of all device-specific limits.

In some examples, the system may dynamically adjust these unified limits as operational conditions change, such as when thermal buildup occurs in one component or when power consumption approaches maximum thresholds in another device. The single user interface element may update in real-time to reflect which device is currently the limiting factor and may provide visual or textual indicators showing the specific constraint that is determining the overall system limits at any given moment.

The time period determining instruction(s) 514 may be configured to calculate sustainable operation durations for audio systems based at least in part on thermal buildup patterns, power consumption rates, and component stress factors to provide time-based operational guidance. In some cases, the period of time output of the time period determining instruction(s) 514 may be used by the parameter determining instruction(s) 516 and/or the limit determining instruction(s) 512 to adjust limits or other settings based on the calculated sustainable operation durations. For example, the parameter determining instruction(s) 516 may utilize the time-based operational guidance from the time period determining instruction(s) 514 to modify how sensor data is interpreted and weighted when determining operational states for different usage scenarios. In some implementations, the limit determining instruction(s) 512 may incorporate the sustainable operation duration calculations to establish time-dependent operational limits that allow an audio and/or audio-visual system to operate in a continuous or unlimited mode (e.g., the audio and/or audio-visual system does not overheat and/or the like). In some cases, the system 500 may use the time period determinations to create adaptive thresholds that automatically adjust operational boundaries based on how long one or more audio and/or audio-visual systems operate, allowing for higher performance levels during shorter listening sessions while implementing more conservative limits during extended use periods.

The parameter determining instruction(s) 516 may be configured to generate operational parameters and settings for audio components by processing combined sensor data, device specifications, and compatibility information to optimize system performance and component longevity.

The user interface instruction(s) 518 may be configured to create and update user interface elements that display operational status, control options, and system parameters while providing visual indicators for operational limits, thermal conditions, and performance metrics.

In some implementations, the parameter determining instruction(s) 516 and user interface instruction(s) 518 may operate together to determine settings or parameters for each audio device that may be presented in a single controllable element of a user display to cause different settings adjustments to each device within an audio and/or audio-visual system. In some cases, the parameter determining instruction(s) 516 may analyze the operational characteristics and capabilities of multiple connected audio devices to calculate device-specific parameter adjustments that may be coordinated through a unified control interface. The user interface instruction(s) 518 may then generate a single controllable element, such as a master volume control or system-wide equalizer setting, that when adjusted by a user may trigger the parameter determining instruction(s) 516 to calculate and apply different corresponding adjustments to each individual device based on each individual device's respective operational requirements and current states or statuses.

For example, when a user interacts with the single controllable element, the parameter determining instruction(s) 516 may determine that a first audio device requires a specific volume adjustment while a second audio device may need a different volume setting, power level modification, or equalization parameter to achieve optimal system-wide performance. The user interface instruction(s) 518 may coordinate the presentation of this unified control while the parameter determining instruction(s) 516 may handle the complex calculations needed to translate the single user input into multiple device-specific commands that maintain system balance and prevent any individual component from exceeding its operational limits.

The alert instruction(s) 520 may be configured to generate notifications and warnings based at least in part on operational thresholds, thermal conditions, and system performance to inform users of potential issues and recommend appropriate adjustments to maintain safe operation. For example, the alert instruction(s) 520 may send an alert to user equipment associated with the system 500, such as a user equipment hosting an application configured to operate with respect to the system 500, to inform the user that a connected audio and/or audio-visual system is approaching and/or exceeding one or more operational limits (e.g., a thermal limit, time limit, and/or the like). In some cases, the alert instruction(s) 520 may generate different types of alerts based on the severity and nature of the operational condition, such as visual warnings displayed on the user interface, audible alerts through connected audio devices, or push notifications sent to mobile applications. The alerts may include specific information about which component is approaching its operational threshold, the estimated time remaining before reaching critical limits, and recommended actions the user may take to maintain continuous operation and/or extend operational periods of the audio and/or audio-visual system. In some implementations, the alert instruction(s) 520 may coordinate with the parameter determining instruction(s) 516 to automatically suggest alternative operational settings that may allow continued use while staying within safe operational boundaries.

In the above examples of FIGS. 1-5 the system is discussed as utilizing cloud-based resources. However, it should be understood that the systems, discussed herein, may be implemented as a fully local deployment as an on-site system, a partial cloud-based partial local deployment system, a fully cloud-based deployment, and/or any combination thereof. For instance, in some implementations, the entire system may be deployed on hardware local to the physical environment (e.g., the system may be in sort range wireless or wired communication with each of the audio devices, installed on one or more of the audio devices, and/or the like). In one specific example, the operations of process 200-300 and system 400 and 500 may be hosted or performed by a single user equipment (e.g., a tablet, personal computer, smart phone, and/or other personal electronic device) as a single control device implementation.

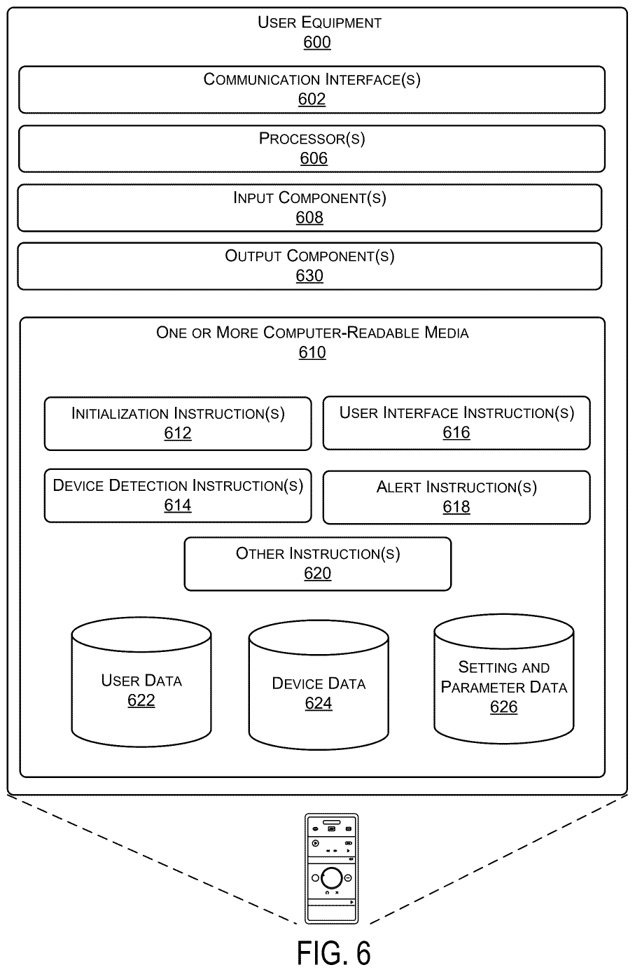

FIG. 6 is an example user equipment 600 that may implement the techniques described herein according to some implementations. For example, the user equipment 600 may include one or more communication interface(s) 602 that enables communication between the user equipment 600 and one or more other local or remote computing device(s) or remote services, such as the cloud-based remote control system 102, audio devices, and/or third-party systems. For instance, the communication interface(s) 602 can facilitate communication with cloud-based services, wireless speakers, amplifiers, or distributed audio management platforms. The communications interface(s) 602 may enable Wi-Fi-based communication such as via frequencies defined by the IEEE 802.11 standards, short range wireless frequencies such as Bluetooth, cellular communication (e.g., 2G, 3G, 4G, 4G LTE, 5G, etc.), infrared communication, or any suitable wired or wireless communications protocol that enables the user equipment 600 to interface with the other computing device(s).

In some implementations, the user equipment 600 may be configured to host a downloadable application that operates in conjunction with the cloud-based system 500, as discussed herein. A user interface of the downloadable application may allow the user equipment 600 to control one or more audio and/or audio-visual systems associated with the user. For example, via the user equipment 600, the user may input user interactions to monitor and adjust or alter one or more settings (e.g., volume and/or the like) of the audio system, causing multiple setting adjustments (e.g., different setting adjustments for each device of the audio system) to be issued by the remote-control system via a single adjustment control or element on the user interface of the user equipment 600, as discussed below.

The user equipment 600 may include one or more processor(s) 606 and one or more computer-readable media 610. Each of the processors 606 may itself comprise one or more processors or processing cores. The computer-readable media 610 is illustrated as including memory/storage. The computer-readable media 610 may include volatile media (such as random access memory (RAM)) and/or nonvolatile media (such as read only memory (ROM), Flash memory, optical disks, magnetic disks, and so forth). The computer-readable media 610 may include fixed media (e.g., RAM, ROM, a fixed hard drive, and so on) as well as removable media (e.g., Flash memory, a removable hard drive, an optical disc, and so forth). The computer-readable media 610 may be configured in a variety of other ways as further described below.

The user equipment 600 may also include one or more input component(s) 608 and one or more output component(s) 630. The input component(s) 608 may include touch screens, keyboards, mouse devices, microphones, cameras, accelerometers, gyroscopes, and/or other input mechanisms that allow users to interact with the user equipment 600. The output component(s) 630 may include displays, speakers, haptic feedback devices, LED indicators, and/or other output mechanisms that provide feedback and information to users of the user equipment 600.

In some cases, the input component(s) 608 and output component(s) 630 may be combined into a single touch-enabled display to provide both input and output capabilities. The touch-enabled display may allow users to interact directly with visual elements presented on the screen while concurrently providing visual feedback and information display functionality to a user. In some implementations, the combined touch-enabled display may support multi-touch gestures, pressure-sensitive inputs, and haptic feedback to enhance user interaction with the audio system control interface. The integrated display may present interactive control elements such as volume sliders, equalizer settings, and system status indicators that users may manipulate through direct touch inputs while receiving real-time visual updates regarding system performance and operational parameters.

Several modules such as instructions, data stores, and so forth may be stored within the computer-readable media 610 and configured to execute on the processors 606. For example, as illustrated, the computer-readable media 610 stores initialization instruction(s) 612, device detection instruction(s) 614, user interface instruction(s) 616, alert instruction(s) 618, and system instruction(s) 620, as well as other instructions, such as an operating system. The computer-readable media 610 may also be configured to store data, such as user data storage 622, device data storage 624, and parameter data storage 626.

The initialization instruction(s) 612 may be configured to coordinate initialization procedures for newly added audio components by communicating with the cloud-based system 500 and facilitating local user interactions during device setup and configuration processes. The initialization instruction(s) 612 may present setup wizards, configuration interfaces, and status indicators to guide users through the process of adding new audio devices to their existing systems. In some cases, the initialization instruction(s) 612 may cause the newly added device and/or other devices of the audio system to perform initialization task and collect sensor data while the tasks are performed. In some cases, the initialization tasks may be informed based on the existing or known audio devices and their associated capabilities.

The device detection instruction(s) 614 may be configured to discover and identify audio devices within the local network environment using various wireless communication protocols and coordinate with the cloud-based system 500 to verify device compatibility and establish communication channels. The device detection instruction(s) 614 may scan for available devices using Bluetooth, Wi-Fi, or other wireless protocols and present discovered devices to users through the user interface. In some implementations, the device detection instruction(s) 614 may utilize broadcast modes of Wi-Fi, Bluetooth, and/or other communication standards to facilitate device discovery and identification processes. The broadcast mode functionality may allow the newly added audio device to transmit discovery signals across the local network environment, enabling user equipment 600 to respond with their identification information, capabilities, and availability status. In some cases, the broadcast mode operations may enable the user equipment 600 to simultaneously communicate with multiple audio devices (e.g., multiple devices of an audio system), allowing for efficient identification and enumeration of available components within the audio system environment.

The user interface instruction(s) 616 may be configured to generate and manage interactive user interface elements that display system status, operational controls, and monitoring information received from the cloud-based system 500 while providing responsive local interactions for user inputs and adjustments. The user interface instruction(s) 616 may create touch-responsive controls, visual indicators, and status displays that allow users to monitor and control their audio systems. In some cases, the user interface instruction(s) 616 may implement local caching and prediction algorithms to provide immediate visual feedback for user interactions while coordinating with the cloud-based system 500 for actual parameter adjustments and system changes.

The alert instruction(s) 618 may be configured to receive and present notifications, warnings, and status updates from the cloud-based system 500 through various local presentation methods including visual alerts, audible notifications, and haptic feedback to inform users of system conditions and recommended actions. The alert instruction(s) 618 may prioritize and filter alerts based on user preferences and current usage patterns. In some implementations, the alert instruction(s) 618 may provide local alert management capabilities, allowing users to acknowledge, dismiss, or snooze notifications while maintaining synchronization with the cloud-based system 500 regarding alert status and user responses.

The system instruction(s) 620 may be configured to manage overall system operations, coordinate between different instruction modules, and maintain system state information for the user equipment 600. In some cases, the system instruction(s) 620 may handle background processes, data synchronization with the cloud-based system 500, and resource management to ensure optimal performance of the downloadable application hosted on the user equipment 600.

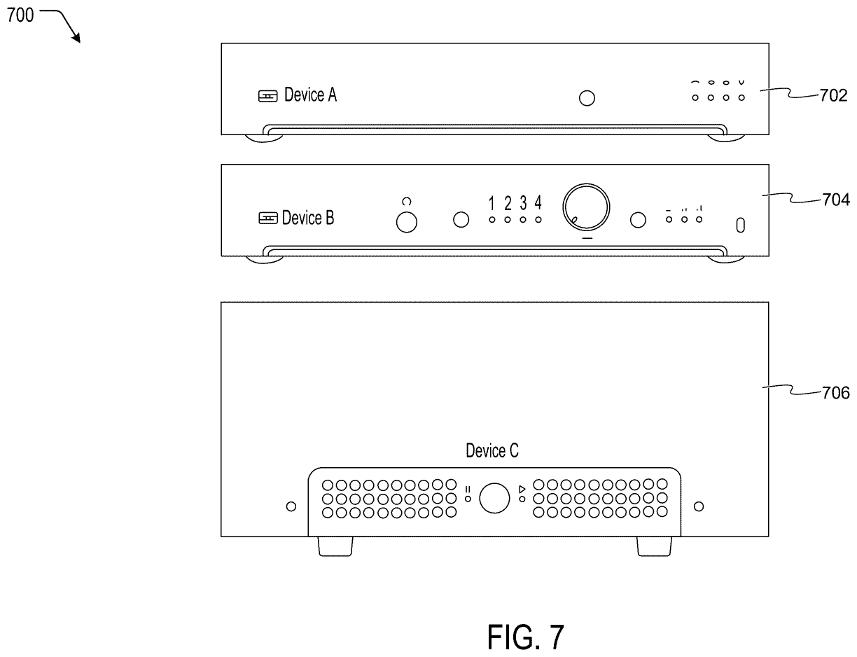

FIG. 7 is an example audio system or stack 700 comprising multiple audio devices configured to operate in tandem to provide a unified audio experience within a physical environment, according to some implementations. In the current example, the audio system or stack 700 includes three audio devices that may be commonly found in home audio setups or professional audio installations.

In the current example, the first audio device 702 may be a mixer or audio interface device configured to receive and process multiple audio input signals from various sources such as microphones, instruments, or digital audio streams. In some cases, the mixer may provide signal routing capabilities, allowing users to direct different audio sources to specific outputs or processing chains. The mixer may include equalization controls, gain adjustments, and effects processing that may be applied to individual input channels or to the overall mixed output signal. In some implementations, the mixer may support both analog and digital input formats, enabling connectivity with a wide range of audio equipment and sources.

The second audio device 704 may be a receiver or preamplifier configured to accept audio signals from the mixer or other source devices and provide signal conditioning, volume control, and routing functions. In some cases, the receiver may include multiple input selection options, allowing users to switch between different audio sources such as streaming services, physical media players, or broadcast signals. The receiver may provide tone controls, balance adjustments, and other audio processing features that may be applied to the incoming signals before they are passed to downstream amplification stages.

The third audio device 706 may be a power amplifier configured to receive line-level audio signals from the receiver or preamplifier and provide the necessary power amplification to drive connected speakers or other transducers. In some cases, the power amplifier may be designed to operate in different classes such as Class A, Class AB, or Class D, each offering different characteristics in terms of efficiency, thermal management, and audio quality. The amplifier may include multiple output channels to support stereo or multi-channel audio configurations, with each channel capable of delivering specific power levels based on the connected speaker impedance and sensitivity ratings. In some implementations, the power amplifier may include protection circuits to prevent damage from overheating, short circuits, or impedance mismatches with connected speakers.

In other examples, additional devices may be added to the audio system or stack 700 such as various speakers, subwoofers, digital signal processors, equalizers, crossover networks, and other audio components. In some cases, the audio system 700 may include passive speakers that rely on the power amplifier for signal amplification, or active speakers that contain built-in amplification circuits. In some implementations, the audio system or stack 700 may include subwoofers configured to reproduce low-frequency audio content, which may be either passive units requiring external amplification or active units with integrated amplifiers and crossover circuits. The system 700 may also incorporate digital signal processors that provide advanced audio processing capabilities such as room correction, time alignment, and frequency response optimization based on the acoustic characteristics of the listening environment. In some cases, additional components may include crossover networks that divide audio signals into specific frequency ranges for distribution to appropriate drivers or speaker elements, ensuring optimal frequency response and preventing damage to individual transducers. The audio system may also include equalizers that allow for precise frequency response adjustments, enabling users to compensate for room acoustics or personal listening preferences. In some examples, the audio system or stack 700 may incorporate streaming devices, digital-to-analog converters, or other source components that expand the input capabilities of the system 700. As discussed herein, each device of the audio system 700 may be added to the user interface provided by the remote-control system.

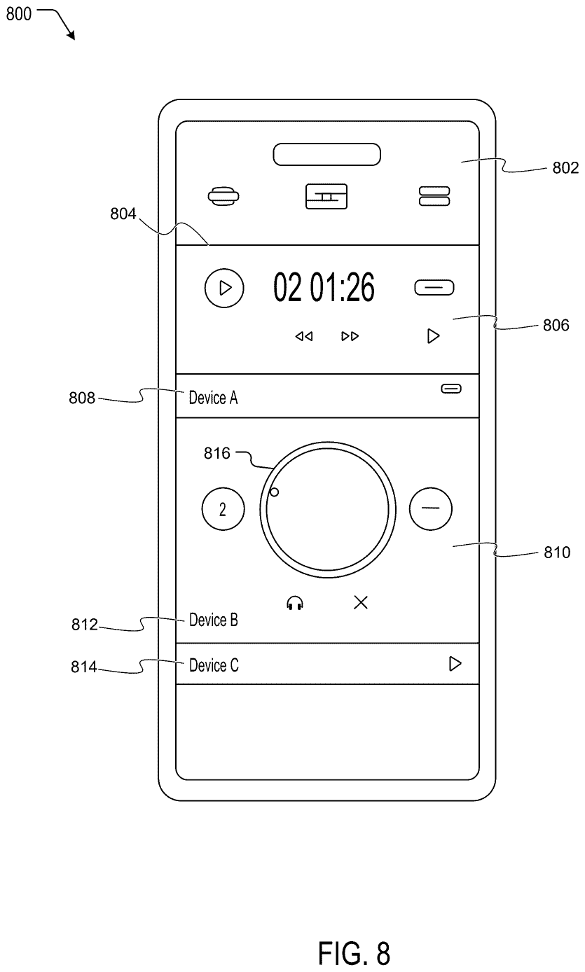

FIG. 8 is an example user interface 802 displayed on user equipment 800 for controlling and monitoring an audio system or stack, such as the audio system or stack 700 of FIG. 7, according to some implementations. In the current example, the user interface 802 may provide a comprehensive control interface that allows users to interact with multiple audio devices within their audio system through a single application interface hosted on the user equipment 800.

The user interface 802 may include media controls 804 positioned at the top portion of the display, which may provide access to media playback functions, source selection options, and content navigation features. In some cases, the media controls 804 may allow users to select different audio sources, browse available content, or access streaming services and local media libraries. The media controls 804 may also provide quick access to frequently used functions such as input switching, preset configurations, or system-wide settings.

Below the media controls 804, the user interface 802 may display playback controls 806 that provide standard audio playback functionality including play, pause, stop, skip, and other transport controls. In some implementations, the playback controls 806 may be context-sensitive, adapting their appearance and functionality based on the currently selected audio source or active content type. The playback controls 806 may also include additional features such as repeat modes, shuffle options, or playlist management functions.

The user interface 802 may include a first audio device indicator 808 that represents one of the connected audio devices within the system. In some cases, the first audio device indicator 808 may display device-specific information such as the device name, current operational status, connection status, or basic operational parameters. The first audio device indicator 808 may be selectable, allowing users to access more detailed controls or information for that specific device.

An expanded component or device interface 810 may be displayed when a user selects or interacts with one of the audio device indicators, such as the second audio device indicator 812 in the current example. In some implementations, the expanded component or device interface 810 may provide detailed controls and monitoring information specific to the selected audio device, including volume controls, equalization settings, operational status indicators, and device-specific parameters. The expanded interface 810 may allow users to adjust settings. It should be understood that in some cases, when the user adjusts the volume control 816, the remote control system may adjust settings for the selected device, device B 812, as well as the other devices of the audio system, such as devices A 812 and device C 814.

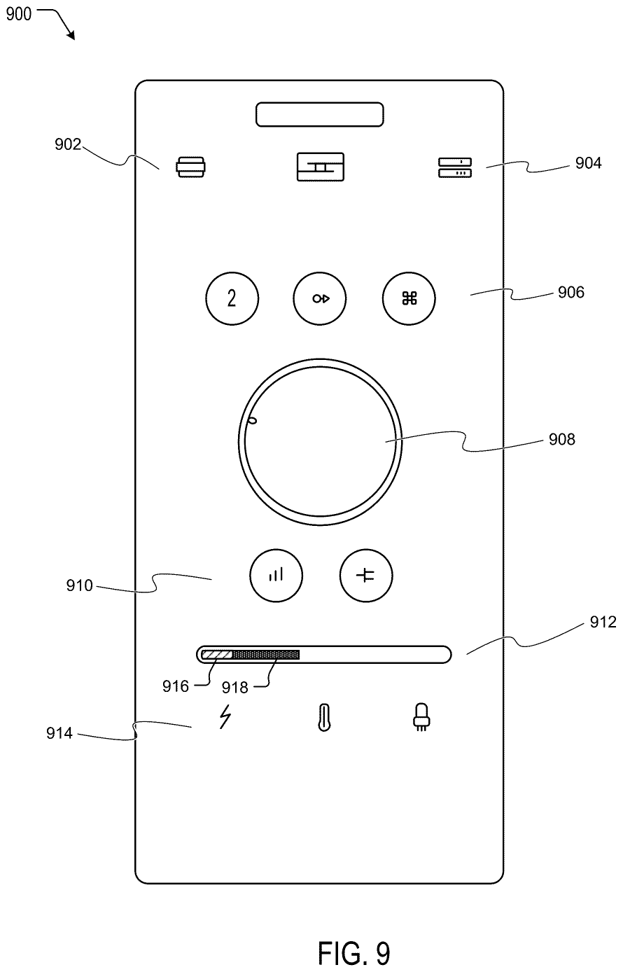

FIG. 9 is an example user interface displayed on user equipment 900 showing detailed audio system control elements and operational monitoring capabilities, according to some implementations. In the current example, the user interface may provide comprehensive control and monitoring functionality for managing audio systems through a single integrated interface hosted on the user equipment 900.

The user interface may include an initialization or setup control 902 positioned at the top portion of the display, which may provide access to system configuration options, device setup procedures, initial calibration functions, and/or the like. In some cases, the initialization or setup control 902 may allow users to add new devices to their audio system, configure system parameters, or access guided setup procedures for newly connected components. The initialization control 902 may also provide access to system diagnostics, compatibility testing, and device verification functions.

Below the initialization control, the user interface may display an audio system selection control 904 that may allow users to switch between different audio system configurations or physical environments within their setup. In some implementations, the audio system selection control 904 may enable users to select between different rooms, zones, or other physical environments as well as between audio system configurations, such as users of the same system or different system in the same physical environment, and/or the like. The selection control 904 may also provide quick access to preset system configurations or user-defined audio profiles.

The user interface may include input and output controls 906 that may provide access to source selection, routing options, and connectivity management functions. In some cases, the input and output controls 906 may allow users to select different audio sources, configure signal routing between devices, or manage input and output assignments for individual components within the audio system. The controls 906 may also provide access to digital and analog input selection, sample rate settings, and other connectivity parameters.

A volume control 908 may be centrally positioned within the user interface, providing primary volume adjustment functionality for the audio system. In some implementations, the volume control 908 may represent a unified control that coordinates volume adjustments across multiple devices within the audio system, with the remote control system calculating appropriate individual device settings based on the unified volume input. The volume control 908 may include visual indicators showing current volume levels and may provide tactile feedback through touch-responsive controls.

The user interface may display gain and mode controls 910 positioned around the volume control 908, which may provide access to amplification settings, operational modes, and signal processing options. In some cases, the gain and mode controls 910 may allow users to adjust input gain levels, select different operational modes such as Class A or Class AB operation, or configure signal processing parameters for individual devices within the audio system. The controls 910 may also provide access to bias settings, power management options, and other advanced operational parameters.

A Class A bias and real-time power meter indicator 912 may be displayed within the user interface to provide real-time monitoring of operational parameters and power consumption. In some implementations, the indicator 912 may show current bias settings, power consumption levels, and thermal status information for devices operating in Class A mode or other operational configurations. The indicator 912 may provide visual feedback regarding power efficiency, thermal conditions, and operational status across the connected audio devices.

The user interface may include system indicators 914 that may provide comprehensive status information regarding the overall health and operational state of the audio system. In some cases, the system indicators 914 may display connectivity status, device health information, operational alerts, and performance metrics for individual components within the audio system. The indicators 914 may also provide visual feedback regarding system synchronization, communication status, and overall system performance.

A first operational limit indicator 916 and current operational level 918 may provide visual feedback regarding operational thresholds and system limits. The indicators may provide real-time feedback regarding how closely the audio system is approaching thermal limits, power consumption thresholds, or other operational boundaries determined by the remote control system based on sensor data and device specifications. In the current example, the current operational level 918 exceeds the first operational limit indicator 916 indicating to a user consuming the user interface that the audio system, including device B, is operating at a level that may degrade the audio experience, cause the audio system to overheat, cause damage to one or more audio devices, such as Device B, and/or the like.

In other examples, the user interface of the user equipment 900 may include additional operational limit indicators, such as the first operational limit indicator 916 and second operational limit indicator, to provide the visual feedback regarding operational thresholds and system limits (e.g., of one or more individual devices as well as the system). In some implementations, the operational limit indicators may display color-coded zones indicating optimal, preferred, safe, operational ranges as well as caution zones, hazardous, degraded audio experience, maximum operational thresholds, and/or the like based on the combined operational parameters of all connected devices and/or individual operational parameters of individual devices associated with the audio system or stack. In some cases, the operational limit indicators may provide real-time feedback regarding how closely the audio system is approaching thermal limits, power consumption thresholds, other operational boundaries, and/or the like determined by the remote-control system based on sensor data, device specifications, historically observed operations, and/or the like.

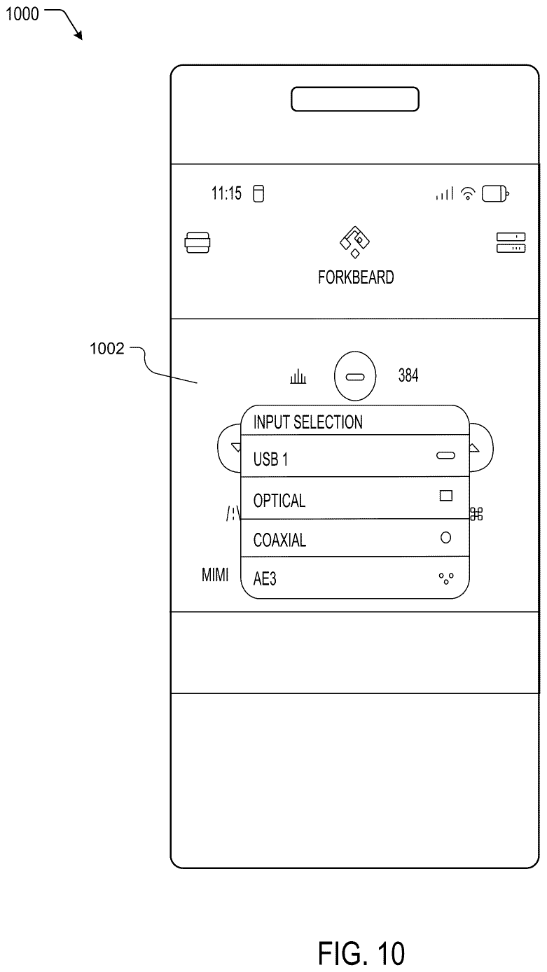

FIG. 10 is an example user interface displayed on user equipment 1000 showing an input selection interface for one or more audio devices of an associated audio system or stack, according to some implementations. In the current example, the user interface may provide streamlined access to input source selection and basic system monitoring through a simplified interface design hosted on the user equipment 1000.

The user interface may display an input selection menu 1002 positioned centrally within the display, which may provide users with options to select from various audio input sources available within the associated audio system or stack. In some cases, the input selection menu 1002 may present multiple input options including digital inputs such as universal serial bus (USB) connections, optical connections, and coaxial connections, as well as analog inputs or other specialized connection types. The input selection menu 1002 may allow users to quickly switch between different audio sources without navigating through complex menu structures or multiple interface screens.

In some implementations, the input selection menu 1002 may display input source labels that correspond to the physical connections available on the connected audio devices within the system. The menu 1002 may show connection status indicators for each input option, allowing users to identify which inputs are currently active, available, or experiencing connectivity issues. The input selection interface may also provide visual feedback when users select different input sources, confirming the selection and indicating any changes in system configuration that result from the input switching.

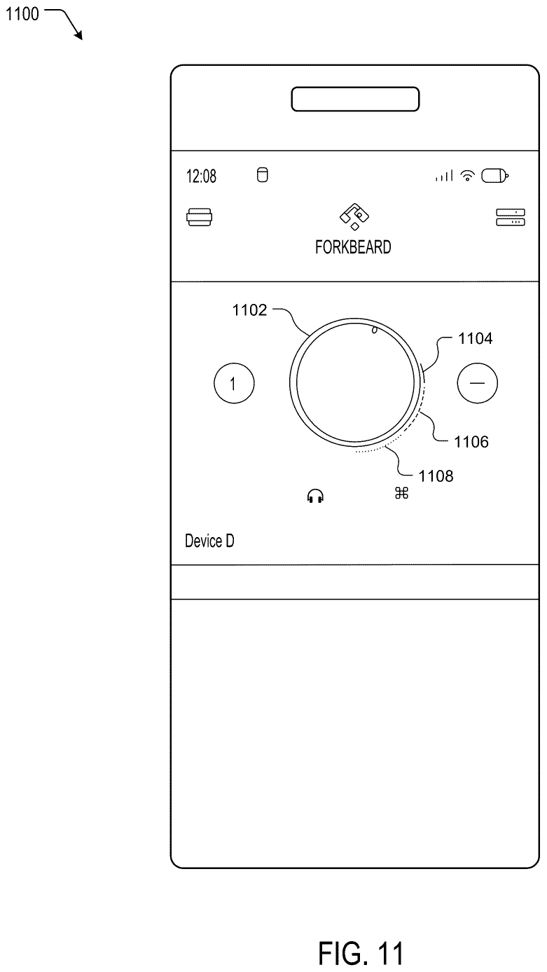

FIG. 11 is an example user interface displayed on user equipment 1100 showing volume control functionality with operational limit indicators, according to some implementations. In the current example, the user interface may provide focused volume adjustment capabilities while displaying real-time operational status information to guide safe system operation.

The user interface may include volume controls 1102 positioned centrally within the display, which may provide primary volume adjustment functionality for the connected audio system. In some cases, the volume controls 1102 may include a circular control interface that allows users to adjust system volume through touch gestures, rotational inputs, or other interaction methods supported by the user equipment 1100. The volume controls 1102 may display numerical volume levels, percentage indicators, or other visual representations of the current volume setting.

The user interface may display a first operational limit indicator 1104, a second operational limit indicator 1106, and a third operational limit indicator 1108 positioned around the volume controls 1102 to provide visual guidance regarding safe operational ranges. In some implementations, the first operational limit indicator 1104 may represent a conservative operational threshold that indicates sustainable operation levels (such as a continuous play level) for extended listening periods, while the second operational limit indicator 1106 may represent a higher threshold indicating warning operational levels for shorter duration use, and the third operational limit indicator 1108 may represent maximum operational limits, and/or the like. As discussed above, the operational limit indicators may utilize color coding, visual patterns, or other graphical elements to communicate different operational zones to users. In some cases, the operational limit indicators may be associated with different metrics or different types of thresholds or limits, such as thermal conditions, power consumption levels, current or voltage levels, duration of current operation, and/or the like. In some implementations, the operational limit indicators 1104-1108 may indicate different thresholds for different audio devices such as the first operational limit indicator 1104 for device A, the second operational limit indicator 1106 for device C, and the third operational limit indicator 1108 for device D. In some cases, each operational limit indicator may be color-coded or visually distinguished to represent the specific device or operational parameter it monitors, allowing users to quickly identify which component or threshold is approaching its operational boundary (e.g., such as the device name and the limit indictor displayed in matching colors, patterns, and/or the like).

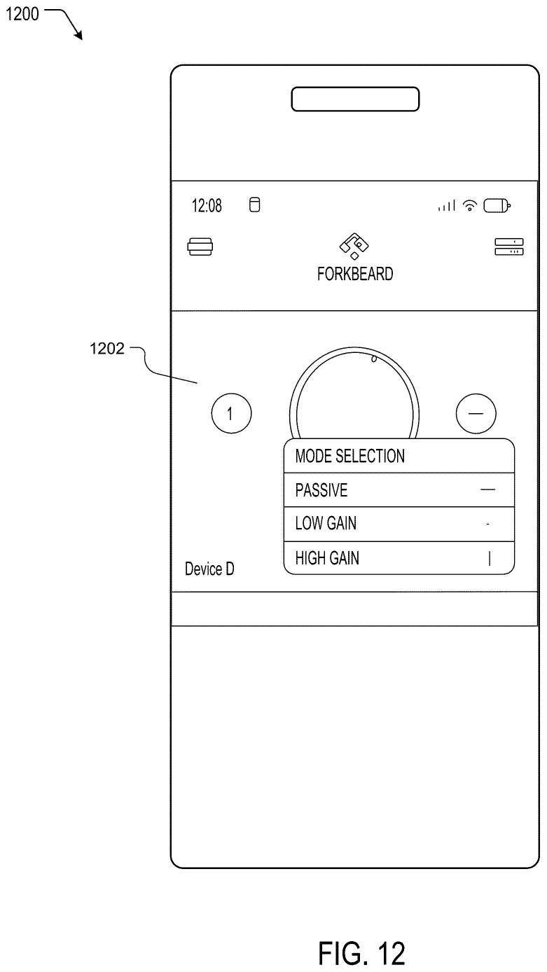

FIG. 12 is an example user interface displayed on user equipment 1200 showing gain selection controls for audio system operation, according to some implementations. In the current example, the user interface may provide streamlined access to amplification mode selection through a single interface design that allows users to configure gain settings for connected audio devices within their audio system.

The user interface may display gain selection controls 1202 positioned centrally within the display, which may provide users with options to select from different amplification modes available within the connected audio system. In some cases, the gain selection controls 1202 may present multiple gain options including “PASSIVE”, “LOW GAIN”, and “HIGH GAIN” settings that correspond to different operational characteristics and power output levels of the connected audio devices. The gain selection controls 1202 may allow users to quickly switch between different amplification modes without requiring detailed technical knowledge of the underlying device specifications or operational parameters.

In some implementations, the gain selection controls 1202 may display mode labels that correspond to the operational capabilities available on the connected audio devices within the system. The controls 1202 may show selection status indicators for each gain option, allowing users to identify which mode is currently active and available for selection. The gain selection interface may also provide visual feedback when users select different gain modes, confirming the selection and indicating any changes in system configuration that result from the gain mode switching.

In some cases, the gain selection controls 1202 may coordinate with the remote control system to determine appropriate gain settings based on the connected speakers, amplifiers, and other audio components within the system. The interface may automatically recommend optimal gain settings based on device compatibility analysis, or may provide warnings when certain gain combinations may result in suboptimal performance or potential component stress. The gain selection controls 1202 may also integrate with other system controls to ensure that volume limits and operational thresholds are appropriately adjusted when different gain modes are selected.

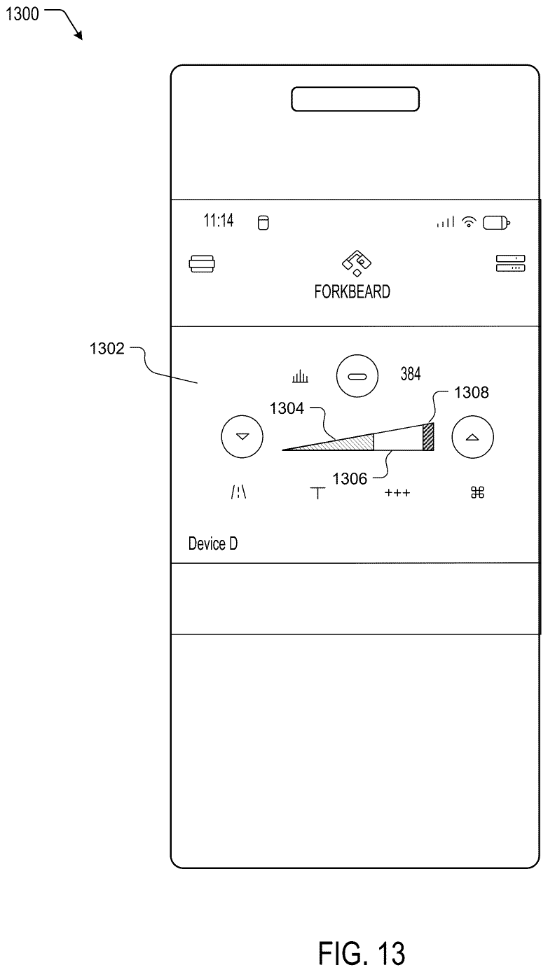

FIG. 13 is an example user interface displayed on user equipment 1300 showing volume control functionality with enhanced operational limit or threshold visualization, according to some implementations. In the current example, the user interface may provide volume adjustment capabilities while displaying one or more operational limits or thresholds.

The user interface may include volume controls 1302, which may provide primary volume adjustment functionality for the audio system including adjustments to two or more devices of the audio system in response to an adjustment via the controls 1302. In some cases, the volume controls 1302 may include interactive control elements that allow users to adjust system volume through direct manipulation, touch gestures, or other input methods supported by the user equipment 1300.

In the current example, the user interface displays a first operational limit indicator 1304 and a second operational limit indicator 1308 positioned at opposite ends of the volume control interface to provide visual boundaries for various operational ranges. In some implementations, the first operational limit indicator 1304 may represent a lower operational threshold (e.g., a warning threshold), while the second operational limit indicator 1308 may represent an upper operational threshold or limit indicating a recommended maximum volume level for the devices of the corresponding audio system. As discussed herein, the operational limit indicators may utilize distinct visual styling, color coding, or graphical elements to clearly communicate operational boundaries to users.

A current volume level indicator 1306 may be positioned to show the current volume setting relative to the established operational limits and, in some cases, may be adjustable as a user input to change the current volume level. In some instances, the current volume level indicator 1306 and/or the volume controls 1302 may display numerical values, percentage indicators, or graphical representations that correspond to the actual volume level being applied to the connected audio devices. The indicator 1306 may provide real-time updates as users adjust volume settings, allowing for immediate visual feedback regarding the current operational state of the audio system.

In some implementations, the current volume level indicator 1306 may change its visual appearance, color, or other characteristics based on proximity to the operational limit indicators 1304 and 1308. The indicator may provide progressive visual warnings as the volume level approaches the upper operational threshold, transitioning through different visual states to communicate potential performance impacts.

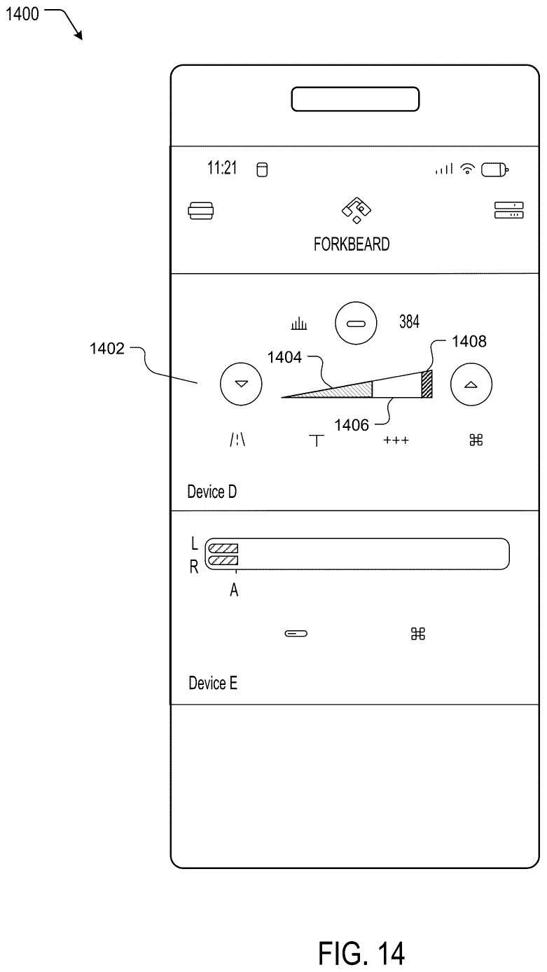

FIG. 14 is another example user interface displayed on user equipment 1400 showing volume control functionality with operational limit visualization and current volume level indication, according to some implementations. In the current example, the user interface may provide volume adjustment capabilities while displaying operational status information to guide users in maintaining peak operational performance of the corresponding audio system.

The user interface may include volume controls 1402 positioned centrally within the display, which may provide primary volume adjustment functionality for the connected audio system. In some cases, the volume controls 1402 may include interactive control elements that allow users to adjust system volume through touch-based interactions, gesture inputs, or other manipulation methods supported by the user equipment 1400. The volume controls 1402 may be configured to coordinate adjustments across multiple audio devices within the system, ensuring balanced operation and optimal performance characteristics.

The user interface may display a first operational limit indicator 1404 and a second operational limit indicator 1408 positioned to provide visual boundaries for optimal operational ranges. In some implementations, the first operational limit indicator 1404 may represent an operational threshold that indicates sustainable operation levels for extended use periods when the volume level is below the first operational limit indicator 1404. The second operational limit indicator 1408 may represent a higher threshold indicating maximum recommended operational levels for the audio devices of the audio system. A current volume level indicator 1406 may be positioned between the operational limit indicators to show the current volume setting relative to the established operational limits 1404 and 1408.

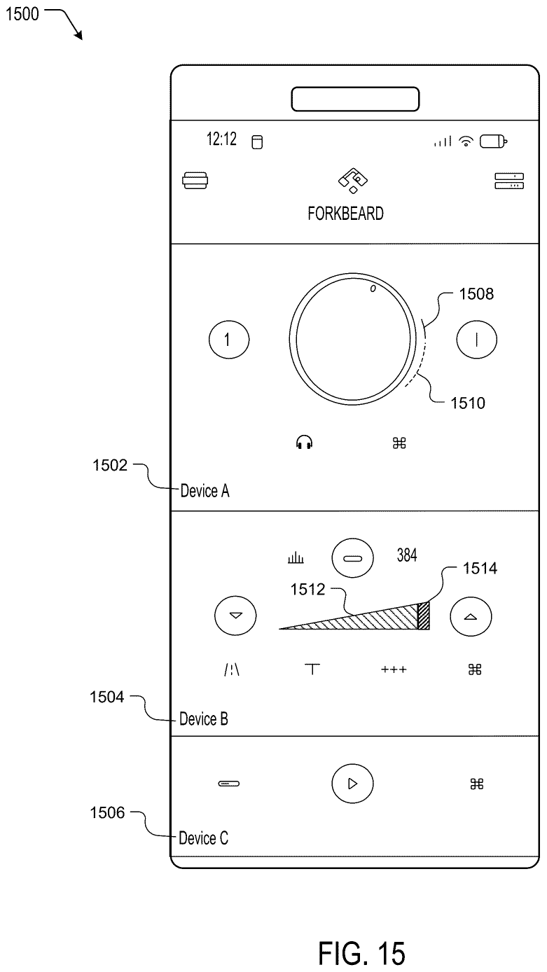

FIG. 15 is an example user interface displayed on user equipment 1500 showing individual device control interfaces for multiple audio components within an audio system, according to some implementations. In the current example, the user interface may provide separate control and monitoring capabilities for each connected audio device while maintaining unified system oversight and coordination.

The user interface may include a first audio device interface 1502 positioned at the top of the display. In some cases, the first audio device interface 1502 may display device-specific operational parameters, status indicators, and control elements tailored to the capabilities and characteristics of the combined audio system including the first audio device or “Device A”. The first audio device interface 1502 may include a first volume limit indicator 1508 and a second volume limit indicator 1510 positioned within a circular control element to provide visual guidance regarding operational ranges for the first audio device. In some implementations, the first volume limit indicator 1508 may represent a warning or continuous play limit that indicates sustainable operational levels for extended listening periods, while the second volume limit indicator 1510 may represent a maximum recommended limit indicating the highest operational threshold for the first audio device within the audio system.

The user interface may display a second audio device interface 1504 labeled “Device B”. In some implementations, the second audio device interface 1504 may include a first operational limit indicator 1512 and a second operational limit indicator 1514 that may be associated with various operational metrics including but not limited to volume control. For example, the first operational limit indicator 1512 and a second operational limit indicator 1514 may correspond to the first volume limit indicator 1508 and the second volume limit indicator 1510 but may be associated with the “Device B” while the first volume limit indicator 1508 and the second volume limit indicator 1510 may be associated with “Device A”. In this example, if the user adjusts the volume with respect to either “Device A” or “Device B”, both volume indicators would adjust accordingly. In other examples, the first operational limit indicator 1512 and second operational limit indicator 1514 may be associated with different metrics than the volume limit indicators 1508 and 1510, such metrics may include thermal conditions, power consumption levels, current draw measurements, impedance matching parameters, signal processing loads, or other device-specific operational characteristics that may, for instance, affect the performance and safety of the second audio device.

The user interface may further include a third audio device interface 1506 labeled “Device C”, which may provide control and monitoring functionality for a third audio device within the audio system. In some implementations, each device interface may display different types of operational limit indicators based on the specific characteristics and monitoring requirements of each individual audio device and/or based on traditional and/or user expected displays or on device user interfaces associated with each individual device.

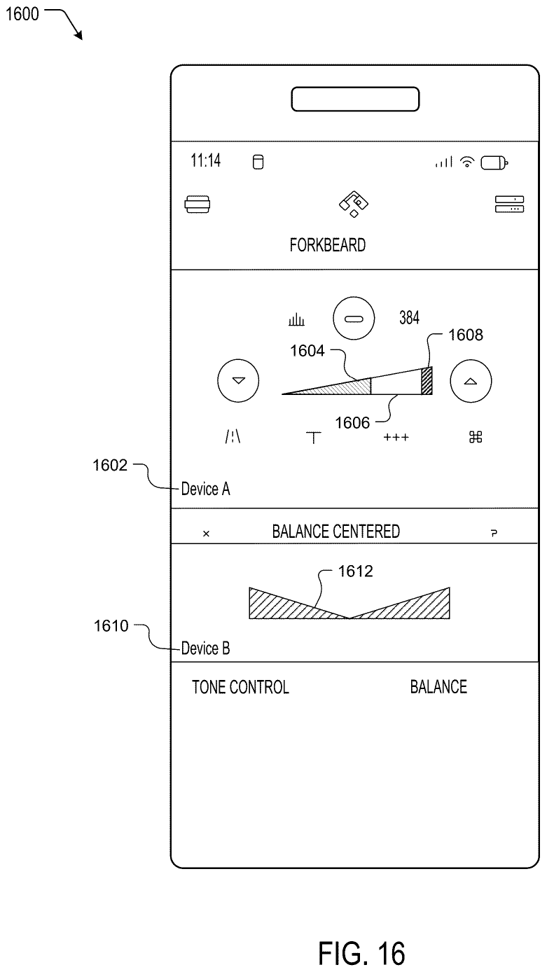

FIG. 16 is an example user interface displayed on user equipment 1600 showing audio control settings with unified audio system balance adjustment capabilities for one or more audio devices of the audio system, according to some implementations. In the current example, the user equipment illustrates a user interface of an audio system or stack having a first audio device indicator 1602 and a second audio deice indicator 1610. The user interface displays a first operational limit indicator 1604, a current volume indicator 1606, and a third operational limit indicator 1608 arranged horizontally across the display to provide visual feedback regarding multiple operational parameters or thresholds, as discussed herein. In some implementations, these operational limit indicators may represent different types of operational boundaries such as thermal limits, power consumption thresholds, or performance parameters for the connected audio devices. In some cases, the indicators 1604 and 1608 may utilize different visual styling, colors, or graphical elements to distinguish between various operational metrics and their respective threshold levels. In some cases, the operational limit indicators 1604 and 1608 may provide substantially real-time monitoring of different aspects of system performance, allowing users to observe multiple operational parameters simultaneously. The indicators may change their visual appearance based on current operational conditions, providing immediate feedback when any monitored parameter approaches or exceeds predetermined thresholds.

The user interface may include balance controls 1612 positioned below the operational limit indicators, which may provide stereo balance adjustment functionality for the audio system. In some implementations, the balance controls 1612 may allow users to adjust the relative volume levels between left and right audio channels, or may provide balance adjustment capabilities for multi-channel audio configurations. The balance controls 1612 may include interactive elements that respond to touch gestures, slider movements, or other input methods supported by the user equipment 1600. In some cases, the balance controls 1612 may provide visual representation of the current left-right balance position, allowing users to see the relative audio distribution between channels. The balance controls 1612 may update in real-time as users adjust the balance controls 1612.

In some implementations, the balance controls 1612 may coordinate with the remote control system to apply appropriate balance adjustments across multiple connected audio devices within the system. The system may calculate device-specific balance adjustments based on the capabilities and characteristics of individual components, ensuring that the desired stereo balance is achieved while maintaining optimal performance across all connected devices of the audio system or stack.

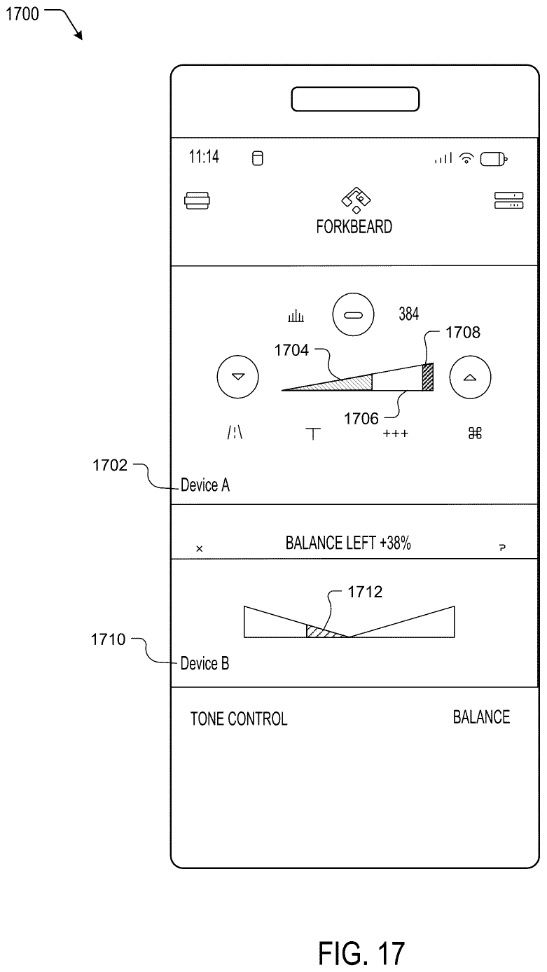

FIG. 17 is another example user interface displayed on user equipment 1700 showing audio control settings with device-specific balance adjustment capabilities, according to some implementations. In the current example, the user interface may provide individual device control and monitoring functionality while incorporating balance adjustment features for stereo audio configurations.

The user interface may include a first audio device indicator 1702 including a first operational limit indicator 1704, a current volume level indicator 1706, and a second operational limit indicator 1708. The user interface may further include a second audio device indicator 1710 and balance controls 1712 positioned in association with the second audio device indicator 1710, which may provide stereo balance adjustment functionality specific to the second audio device or for the overall audio system configuration.

In some implementations, the balance controls 1712 may allow users to adjust the relative audio distribution between left and right channels while monitoring the operational status of individual devices through the operational limit indicators. The balance controls 1712 may include interactive elements that respond to user inputs while coordinating with the remote control system to ensure that balance adjustments are applied appropriately across the audio devices of the audio system. In the current example, the balance of the audio system may be to the left of the physical environment housing the audio system.

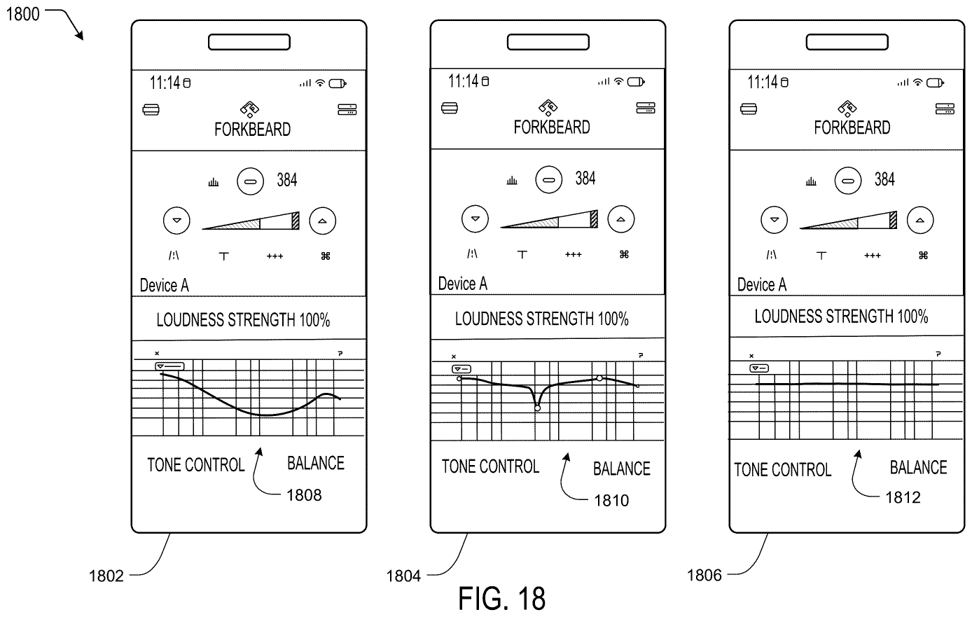

FIG. 18 is an example user interface displayed on user equipment 1800 showing multiple display interfaces with equalizer curve visualization for audio system including one or more audio devices, according to some implementations. In the current example, the user equipment 1800 may provide three separate display interfaces that demonstrate different balance curve configurations and their visual representations within the audio control system.

The user equipment 1800 may include a first display interface 1802, a second display interface 1804, and a third display interface 1806. In the current example, the display interfaces 1802-1806 provide three example balance curves that may be set by a user of the system. In each example 1802-1806, the remote-control system may adjust the settings of each individual device of the corresponding audio system or stack to implement the selected balance curve within the associated physical environment.

In the current example, the display interface 1802-1804 also illustrates corresponding equalizer curves visualization and control interfaces 1808-1812. For example, using the equalizer curves visualization and control interfaces 1808-1812 a user may adjust a parametric equalizer (EQ) setting of the combined audio devices and/or each individualized audio device of the audio system. For instance, the parametric EQ may be controlled provide precise control over specific frequencies of the audio output by the audio devices. In some cases, the equalizer curves visualization and control interfaces 1808-1812 may allow for adjustment of at least three parameters including gain, center frequency, and bandwidth.

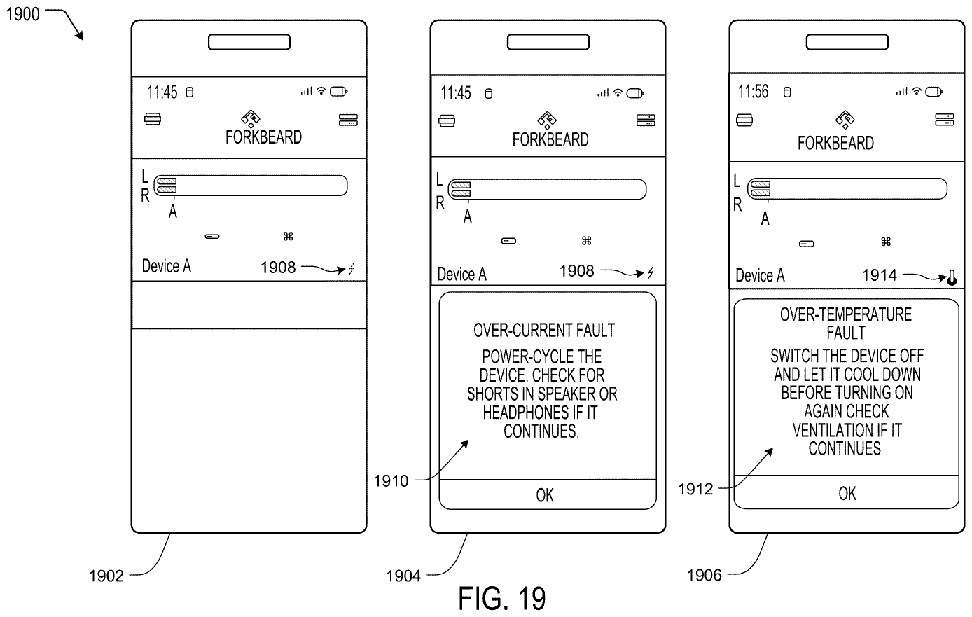

FIG. 19 is an example user interface 1900 displayed on user equipment showing various warning notifications and alert messages for the route-control system, according to some implementations. In the current example, the user interfaces 1900 may demonstrate various different warnings that may be presented to a user.

For example, a first user interface 1902 an over-current warning 1908 has been activated or presented to the user. The over-current warning 1908 may be a warning indicator that may flash, change colors, patterns, and/or the like to indicate a predicted or pending over-current fault and/or an experienced over-current fault associated with one or more devices of the audio system or stack. For instance, the remote-control system may predict or otherwise anticipate an over-current event based on sensor data received from one or more of the audio devices of the audio system or stack and the current settings applied by a user. In this instance, the user interface 1902 may provide an early warning via the over-current warning indicator 1908 prior to one or more of the devices experiencing an over-current event and having to shut down.

A second user interface 1904 is shown with the over-current warning indicator 1908 active and presenting an over-current warning message 1910. In this example, the over-current warning indictor 1908 and message 1910 may be triggered when one or more audio devices within the audio system detect electrical current levels that exceed predetermined thresholds. The warning message 1910 may instruct users to power-cycle the affected device(s) and check for potential short circuits in connected speakers or headphones if the condition persists.

A third user interface 1906 is shown with a temperature warning indicator 1914 active and presenting a temperature or overheating warning message 1912. In some implementations, the temperature warning indicator 1914 may be activated when thermal sensors within one or more of the audio devices indicate to the remote-control system the device(s) are operating temperatures that approach or exceed one or more operational limits or thresholds. The warning message 1912 may provide a user with guidance or recommendations for addressing thermal issues. In some cases, the warning message 1912 may recommend switching off the affected device including shutting down the audio device to allow cooling, checking ventilation systems, ensuring adequate airflow around the audio components, and/or the like.

In some implementations, the warning notifications including indicators and messages may be displayed in the user interface 1900 based at least in part on monitoring the sensor data received from the audio devices with respect to various operational thresholds or limits. The warning messages 1910 and 1912 may provide specific troubleshooting steps tailored to the type of condition detected, helping users maintain safe or optimal operation of their audio systems while preventing potential damage to connected components.

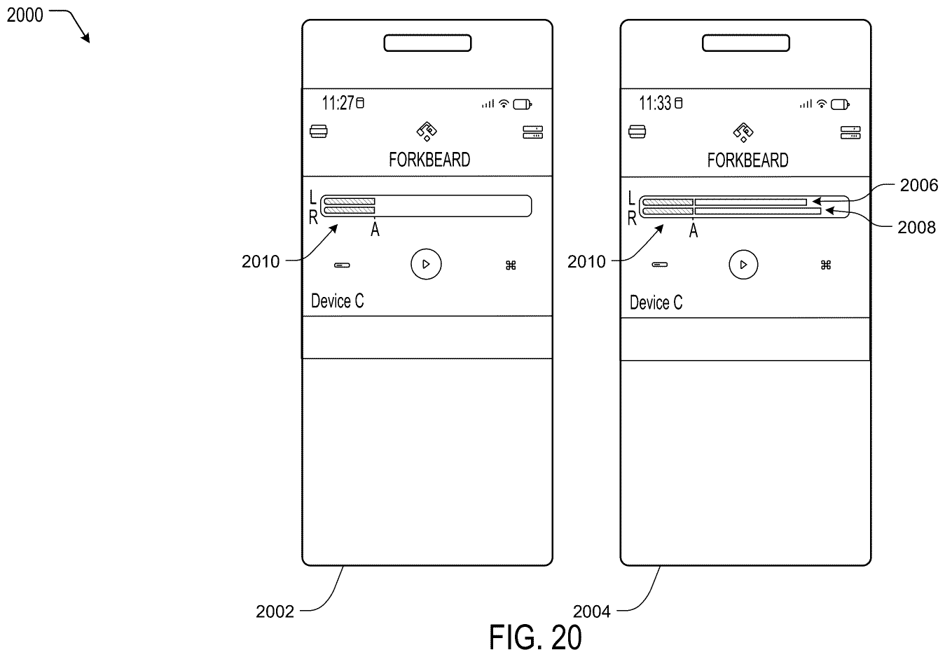

FIG. 20 is an example user interface 2000 displayed on user equipment showing amperage monitoring and control capabilities for audio devices within an audio system, according to some implementations. In the current example, the user interface 2000 may provide real-time monitoring of electrical current and amperage-related parameters for the audio components of an audio system or stack. In the current example, a first user interface 2002 displaying amperage limit indicators 2010 that a threshold or limit associated with the amperage of one or more audio devices within the system, such as a right and left speaker in the illustrated example. The second user interface 2004 illustrates an example in which the current amperage levels 2006 and 2008 are exceeding the recommended limits or thresholds as shown by the amperage limit indicators 2010.

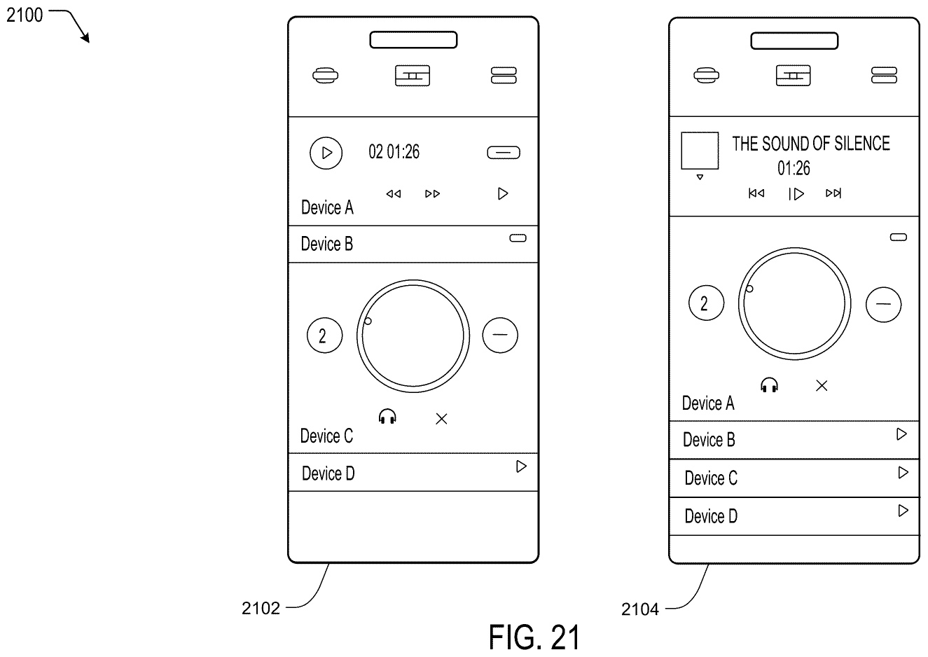

FIG. 21 is an example user interface 2100 displayed on user equipment showing dual interface configurations for comprehensive audio system monitoring and control, according to some implementations. In the current example, the user interface 2100 may provide simultaneous access to multiple control perspectives or operational views within a single display environment, allowing users to monitor and adjust different aspects of their audio system configuration.

The user interface 2100 may include a first user interface 2102 which may display device-specific controls, volume adjustments, operational limit indicators, and other real-time monitoring data that allows users to manage individual components within a corresponding audio system or stack. The first user interface 2102 may include interactive elements such as volume controls, balance adjustments, and status indicators that respond to user inputs while coordinating with the remote control system to apply appropriate settings across connected devices. In another example, a second user interface 2104 displays a different selected device, such as Device A but maintains the volume control interface to control the individual devices of the audio system or stack, as discussed above. Accordingly, it should be understood that by adjusting the volume control of either Device B in user interface 2102 or Device A in the user interface 2104, the remote-control system may adjust settings associated with each or some of the devices A-D associated with the audio system or stack.

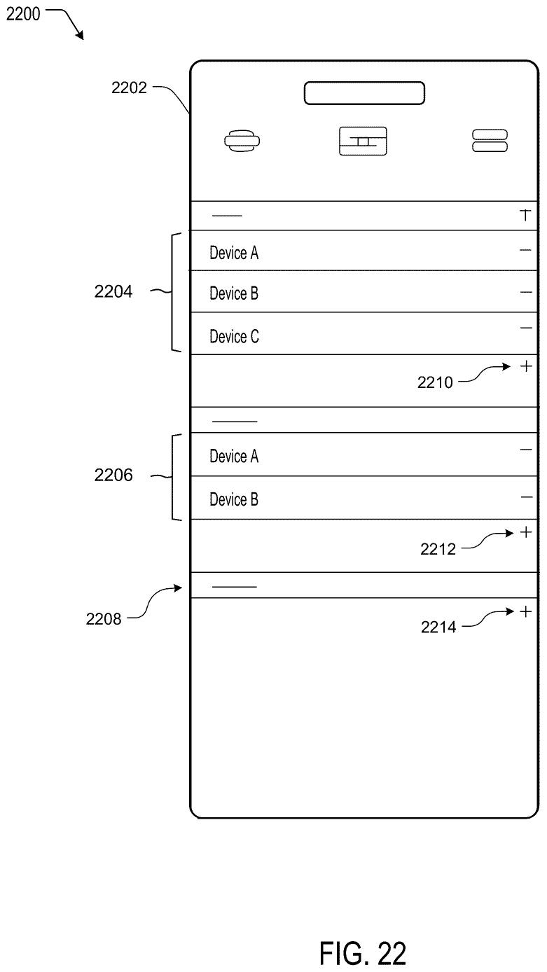

FIG. 22 is an example user interface 2200 displayed on user equipment 2202 showing multiple audio systems or stacks controlled by the remote-control system, according to some implementations. In the current example, the user interface 2200 may include a first audio device system or stack 2204 representing a first audio configuration comprising multiple connected audio devices such as Device A, Device B, and Device C. The user interface 2200 may further include a second audio device system or stack 2206 positioned below the first audio device system or stack 2204, in the current example, and which includes a separate audio configuration comprising only Device A and Device B, such as a different stack within the same physical environment having some overlapping devices (e.g., Device A and Device B). In the current example, the user may add an additional stack or system via the interface control 2208. For instance, the user may add another audio system or stack 2208 having an audio configuration comprising Device A, Device C, and/or another Device D (not shown). In the current example, the user interface 2200 may also include controls 2210, 2212, and 2214 for adding devices to the respective audio system or stack 2204, 2206, and/or 2208. In some cases, the user may also remove devices from the respective audio system or stack via the controls 2210, 2212, and 2214.

In some implementations, each audio system or stack 2204-2208 may correspond to different users within the same physical environment or across multiple locations. For example, the first audio device system or stack 2204 may be associated with a first user having specific audio preferences, device configurations, and operational settings, while the second audio device system or stack 2206 may be associated with a second user with different audio requirements and system configurations. In some cases, the remote-control system may maintain separate user profiles for each stack, allowing individual users to customize their audio experience, operational parameters, and device settings independently. The system may store user-specific preferences such as volume limits, equalization settings, balance configurations, and operational thresholds for each respective audio system or stack. In some implementations, the remote-control system may provide user authentication or identification features that automatically load the appropriate stack configuration and settings when a particular user accesses the system through their user equipment.

In the current example, multiple stacks 2204-2208 are illustrated on a single user interface. However, it should be understood that in some implementations, each stack 2204-2206 may be displayed as independent screens or interfaces, such that each stack 2204-2206 may be displayed independently, such as via a horizontal scroll or swipe control and/or the like.

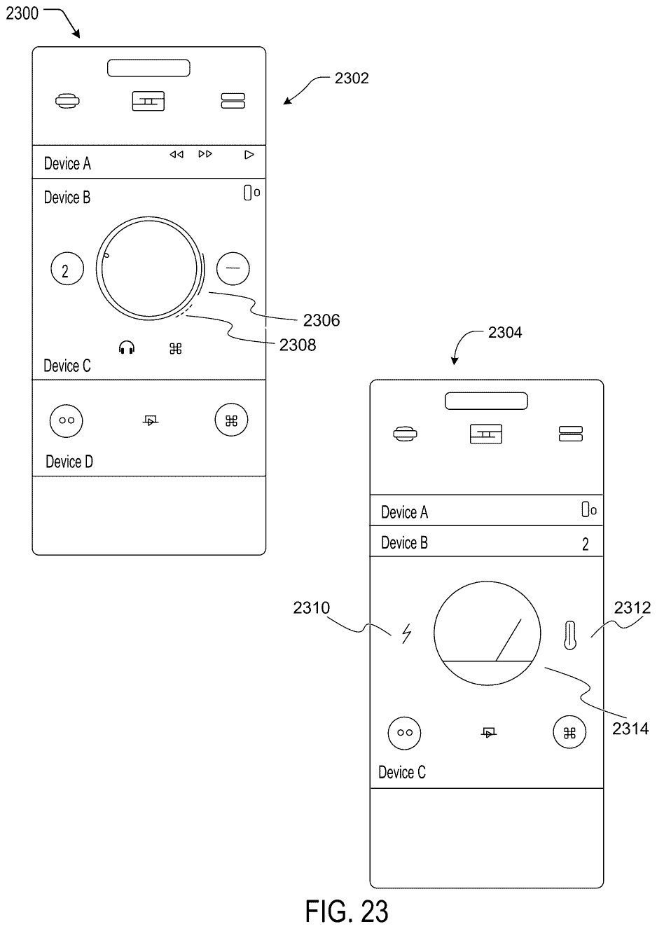

FIG. 23 is an example user interface 2300 displayed on user equipment showing enhanced monitoring and warning capabilities for audio system operation, according to some implementations. In the current example, a first user interface 2302 illustrates a volume control interface having a first volume limit indicator 2306 and a second volume limit indicator 2308. In some implementations, the first volume limit indicator 2306 and second volume limit indicator 2308 may display volume thresholds or limits associated with operation of the audio system or stack. In some cases, the first volume limit indicator 2306 may represent a sustainable operational threshold for extended listening periods, while the second volume limit indicator 2308 may represent a maximum recommended operational limit for shorter duration use or peak performance levels.

The example 2300 may further include a second user interface 2304 displaying a warning and status information for a second device of the audio system, such as Device B. In some cases, the second user interface 2304 may include an over-current warning indicator 2310 that provides visual alerts when current levels approach or exceed predetermined thresholds for one or more audio devices within the audio system or stack. The over-current warning indicator 2310 may utilize distinctive visual styling, color changes, or animation effects to draw user attention to potential electrical issues that may require immediate attention.

In some implementations, the second user interface 2304 may also include a temperature warning indicator 2312 that monitors thermal conditions of the audio devices and provides alerts when operating temperatures approach or exceed operational limits or thresholds. In some cases, the temperature warning indicator 2312 may display real-time temperature data and may change its visual appearance based on the severity of conditions detected by the remote-control system. The user interface 2300 may include a status indicator 2314 to, for instance, provide the user with status or data associated with a real-time metrics of the operational current levels.

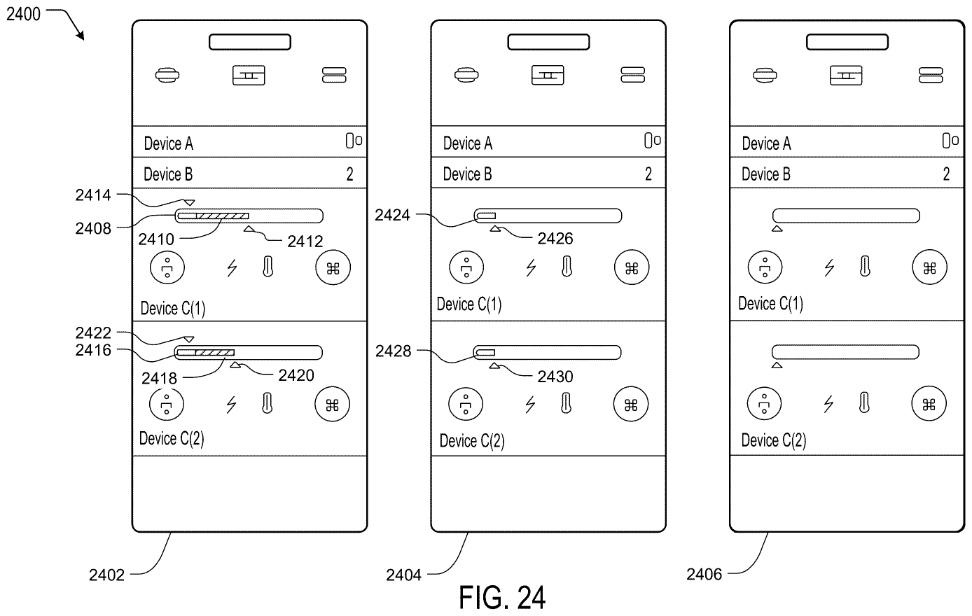

FIG. 24 is an example user interface display 2400 displayed on user equipment showing current monitoring and control capabilities with multiple operational indicators for multiple audio devices of an audio system or stack, according to some implementations. In the current example, the user interface display 2400 may provide monitoring of electrical current parameters across multiple audio devices of an audio system or stack while displaying various operational thresholds and limits to guide system operation and user selection of operational settings.

The user interface display 2400 may include a first user interface 2402 that includes a first current indicator 2408 that displays real-time current consumption data for a first audio device (e.g., “device C(1)”) of the audio system or stack and second current indicator 2416 that displays real-time current consumption data for a first audio device (e.g., “device C(2)”) of the audio system or stack. The first current indicator 2408 may include a first current level indicator 2410 showing the actual current level based on the user selected settings. The first current indicator 2408 may also include a first current limit indicator 2412 indicating a maximum recommended setting level and a second current limit indicator 2414 that may represent different operational thresholds such as warning level or threshold and/or a continuous play or operation level or threshold for the Device C(1). In some implementations, the second current indicator 2416 may include a second current indicator 2418 showing current operational setting along with a third current limit indicator 2420 illustrating a maximum recommended setting for Device C(2) and a fourth current limit indicator 2422 that may represent different operational thresholds such as warning level or threshold and/or a continuous play or operation level or threshold for the Device C(2).

In the current example, a second user interface 2404 is shown. In some cases, the second user interface 2404 may display a third current indicator 2424 with a fourth current limit indicator 2428 that may illustrate both Device C(1) and Device C(2) operating within corresponding current level limit indicators 2426 and 2430, such that both devices may operate in a continuous play or unlimited play setting. A third user interface 2406 may illustrate the audio system or stack in a standby mode.

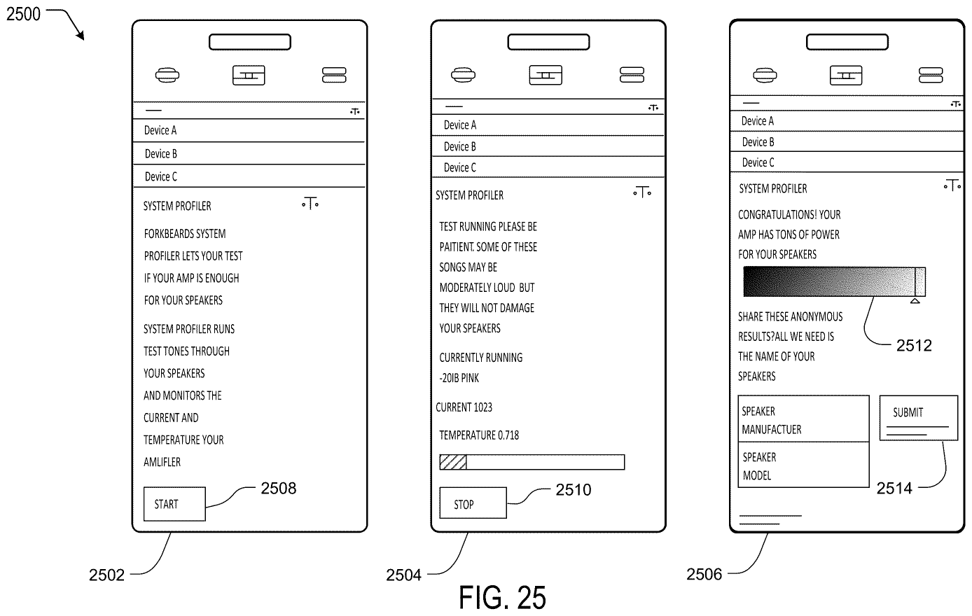

FIG. 25 is an example user interface display 2500 displayed on user equipment showing system profiling and compatibility testing capabilities for audio devices within an audio system, according to some implementations. In the current example, the user interface display 2500 may provide guided testing procedures that allow users to evaluate device compatibility and optimize system performance through automated testing sequences.

A first user interface 2502 may display initial setup options for conducting compatibility testing between connected audio devices. In some cases, the first user interface 2502 may include a start compatibility test button 2508 positioned at the bottom of the interface, which may initiate automated testing procedures to evaluate how newly added or existing devices interact within the audio system configuration. The start compatibility test button 2508 may trigger the remote-control system to begin collecting sensor data, performing signal analysis, and measuring operational parameters across all connected devices.

The user interface display 2500 may further include a second user interface 2504 that displays testing progress and real-time monitoring information during the compatibility evaluation process. In some implementations, the second user interface 2504 may include a stop compatibility test button 2510 that allows users to terminate the testing sequence if needed. The second user interface 2504 may display progress indicators, current test parameters, and preliminary results as the remote-control system evaluates device interactions, thermal characteristics, and electrical compatibility between components.

A third user interface 2506 may be displayed upon completion of the compatibility testing sequence. In some cases, the third user interface 2506 may include a power meter 2512 that displays power consumption analysis and efficiency metrics determined during the testing process. The third user interface 2506 may also include a submit or confirm settings button 2514 positioned at the bottom of the display, which may allow users to accept the recommended operational parameters and device configurations determined by the remote-control system based on the compatibility testing results. In some implementations, the power meter 2512 may provide visual feedback regarding optimal power settings, thermal management recommendations, and suggested operational limits for the tested audio system configuration.

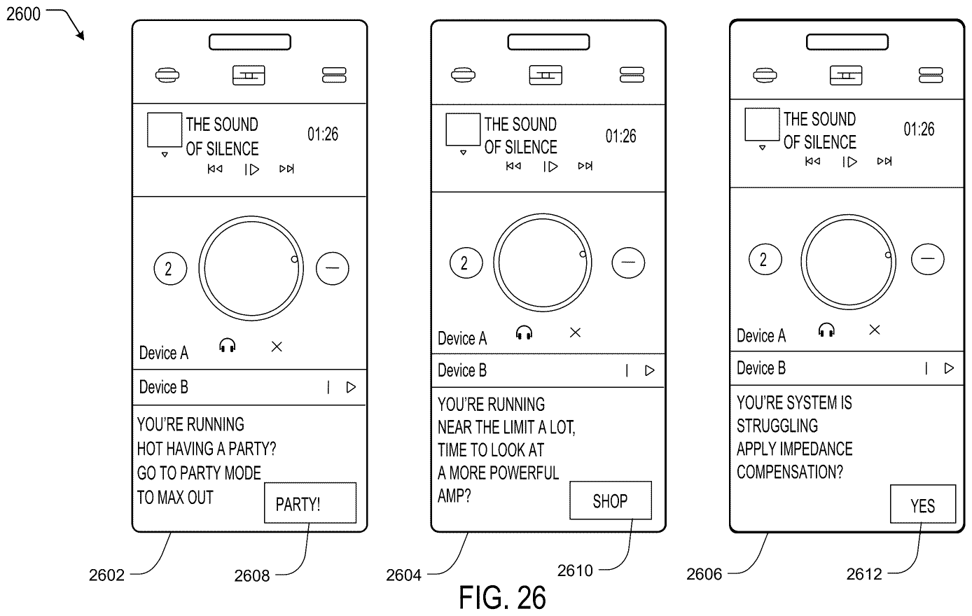

FIG. 26 is an example user interface display 2600 displayed on user equipment showing example warning or alert messages that may be generated by a remote-control system in response to operating the audio system or stack, according to some implementations. In the current example, the user interface display 2600 may provide users with different operational modes and purchasing options based on system analysis and compatibility testing results.

A first user interface 2602 may display warning message upon detecting that one or more devices of the audio system or stack are heating up. In this example, the user interface 2602 may present to the user an option to enter a continuous play configuration by selecting a user option 2608 within the warning message or alert.

A second user interface 2604 may illustrate a second warning message or alert associated with a determination that the user often sets their audio system or stack at or near a limit of one or more of the associated audio devices. In this example, the warning message or alert may allow the user to enter a shopping mode via a user selectable option 2610. In response to a selection of the option 2610 the user interface 2604 may transition to a shopping interface and the remote-control system may present a number of compatible replace devices that may operate at the level often set by the user.

A third user interface 2606 may display a warning or alert message when the remote-control system detects that one or more devices are struggling to operate at the user's desires level. In this example, the user interface 2606 may present a selectable option 2612 to enter or apply an impedance compensation or other setting for the audio system or stack to allow the struggling device to operate.

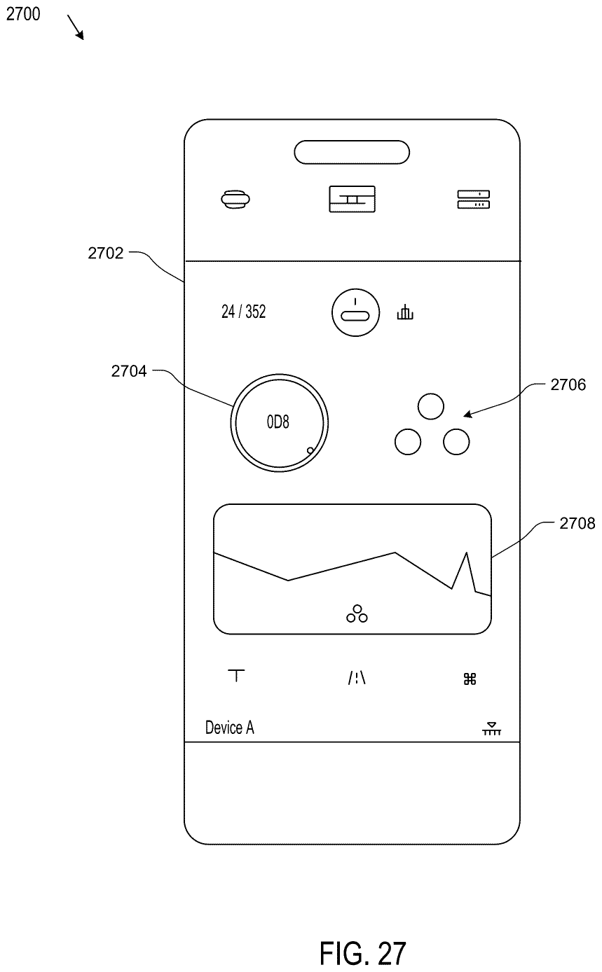

FIG. 27 is an example user interface display 2700 displayed on user equipment showing parametric equalization control capabilities for audio system operation, according to some implementations. The user interface 2702 may include a volume control 2704 which may provide primary volume adjustment functionality while coordinating with the parametric equalization settings to maintain optimal system performance. In some cases, the volume control 2704 may dynamically adjust its operational limits based on the current equalization settings applied to the audio system, ensuring that frequency-specific adjustments do not cause individual devices to exceed their operational thresholds.

The user interface 2702 may display parametric equalizer buttons 2706 arranged horizontally across the interface. In some implementations, the parametric equalizer buttons 2706 may provide quick access to predefined equalization presets, frequency band selections, or specific adjustment modes tailored to different listening environments or audio content types. The parametric equalizer buttons 2706 may allow users to switch between various equalization configurations such as bass boost, vocal enhancement, or room correction settings without requiring detailed manual adjustments to individual frequency parameters.

The user interface 2702 may further include a parametric equalizer curve interface 2708 displayed in the lower portion of the interface. In some cases, the parametric equalizer curve interface 2708 may provide a visual representation of the current frequency response characteristics applied to the audio system or stack. The parametric equalizer curve interface 2708 may display interactive control points, frequency response curves, and adjustment handles that allow users to modify specific frequency bands, gain levels, and bandwidth parameters through direct manipulation of the graphical interface elements.

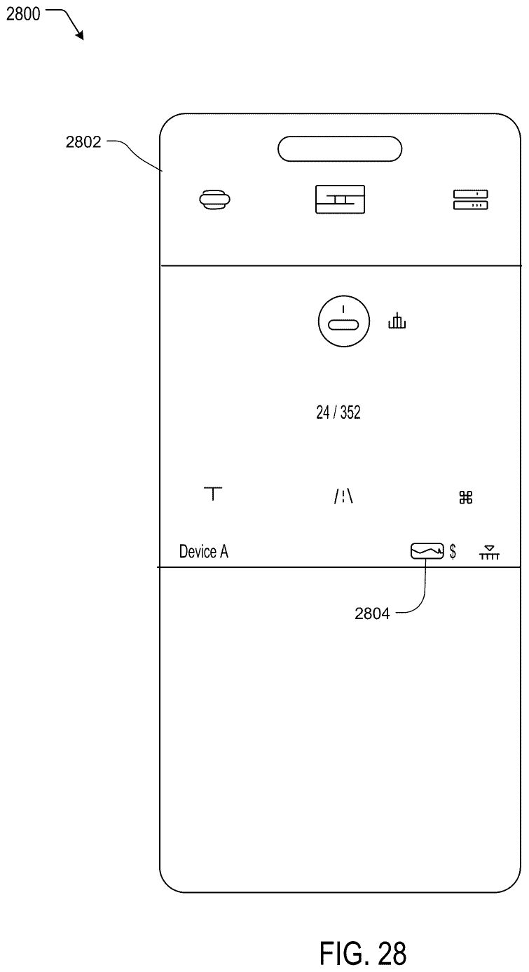

FIG. 28 is an example user interface display 2800 displayed on user equipment showing feature purchase options for an audio system or stack, according to some implementations. In the current example, the user interface 2802 may display feature purchase controls or options 2804 to allow the user to add or replace various devices of the audio system or stack to improve performance. For example, the system may determine specific audio devices or additional features that may be more compatible or offer improved performance of the audio system or stack. In this example, the remote-control system may cause the user interface display 2800 to provide these recommendations via the feature purchase controls or options 2804.

In some cases, the feature purchase controls or options 2804 may display pricing information, feature descriptions, and trial options that allow users to evaluate premium functionality before making purchasing decisions. The controls 2804 may also provide subscription-based options for ongoing access to cloud-based processing capabilities, regular software updates, or access to expanded device compatibility databases maintained by the remote-control system provider.

Although the discussion above sets forth example implementations of the described techniques, other architectures may be used to implement the described functionality and are intended to be within the scope of this disclosure. Furthermore, although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

### EXAMPLE CLAUSES

A. A method comprising: presenting, on a display of a user equipment and to a user, a user interface associated with an audio system comprising two or more audio devices within a physical environment; receiving, via the user interface, a user input to adjust a setting associated the audio system; determining, based at least in part on the user input and first sensor data associated with a first audio device of the two or more audio devices, a first control signal for configuring the first audio device; determining, based at least in part on the user input and second sensor data associated with a first audio device of the two or more audio devices, a second control signal for configuring the second audio device, the second control signal different than the first control signal; and sending the first control signal to the first audio device and the second control signal to the second audio device.
B. The method of A, wherein determining the first control signal is based at least in part on the second sensor data and determining the second control signal is based at least in part on the first sensor data.
C. The method of A or B, wherein determining the first control signal is based at least in part on third-party data associated with operations of the first audio device.
D. The method of A-C, further comprising: determining, based at least in part on the first sensor data and the second sensor data, a first operational threshold and a second operational threshold associated with the audio system, the second operational threshold different than the first operational threshold; and presenting the first operation threshold and the second operational threshold on the display of the user equipment.
E. The method of D, wherein the first operational threshold is a continuous play threshold and the second operational threshold is a recommended operational limit of the audio system.
F. The method of D, wherein presenting the first operation threshold and the second operational threshold on the display of the user equipment further comprises presenting a user input control, a current operational status indictor, a first limit indicator associated with the first operation threshold, and a second limit indicator associated with the first operation threshold on the display of the user equipment.
G. The method of D, further comprising: receiving, third sensor data from the first audio device while the first audio device and the second audio device are operating; and responsive to determining, based at least in part on the third sensor data, that the audio system has met or exceeded the first operational threshold, presenting a warning message on the display of the user equipment.
H. The method of G, wherein the warning message is associated with at least one of the following: a temperature; an electrical current; an amperage; a Class bias; or a period of time.
I. A remote-control system comprising: one or more processors; and one or more computer-readable media storing instructions that, when executed by the one or more processors, cause the remote-control system to perform operations comprising: presenting, on a display, a user interface including a first section associated with a first audio device of an audio system and a second section associated with a second audio device of the audio system, a first user input control, a first limit indicator, and a second limit indictor, the first limit indicator associated with a first operational threshold of the first audio device or the second audio device and the second limit indicator associated with a second operational threshold of first audio device or the second audio device; receiving, via the first user input control, a first user input to adjust a first setting associated with the audio system; determining, based at least in part on the first user input, a first control signal for configuring the first audio device and a second control signal different than the first control signal for configuring the second audio device; and sending the first control signal to the first audio device and the second control signal to the second audio device.
J. The system of I, wherein the first limit indicator is a continuous play threshold and the second limit indicator is a recommended operational limit of the audio system.
K. The system of I or J, wherein the operations further comprise: responsive to receiving a second user input to transition from the first section to the second section, presenting on the display a second user input control, the first limit indicator, and the second limit indictor; receiving, via the second user input control, a third user input to adjust a second setting associated with the audio system; determining, based at least in part on the user input, a third control signal for configuring the first audio device and a fourth control signal different than the first control signal for configuring the second audio device; and sending the third control signal to the first audio device and the fourth control signal to the second audio device.
L. The system of K, wherein the first setting is a volume and the second setting is an electrical current.
M. The system of any of I-L, wherein the operations further comprise:
receiving, first sensor data from the first audio device and second sensor data associated with the second audio device while the audio system is in operation; and
responsive to determining, based at least in part on the first sensor data and the second sensor data, that the audio system has met or exceeded first limit indicator, presenting a first warning on the display.
N. The system of M, wherein the operations further comprise: responsive to determining, based at least in part on the first sensor data and the second sensor data, that the audio system has met or exceeded second limit indicator, presenting a second warning on the display.
O. The system of M, wherein the first warning is an icon and the second warning is a message.
P. One or more computer-readable media storing instructions that, when executed by one or more processors, cause the one or more processors to perform operations comprising: receiving, via a first user input control associated with a first audio device of an audio system, a first user input to adjust a first setting associated with the audio system; determining, based at least in part on the first user input, a first control signal for configuring the first audio device and a second control signal different than the first control signal for configuring a second audio device of the audio system; sending the first control signal to the first audio device and the second control signal to the second audio device; receiving, via a second user input control associated with the second audio device, a second user input to adjust a second setting associated with the audio system; determining, based at least in part on the second user input, a third control signal for configuring the first audio device and a fourth control signal different than the first control signal for configuring the second audio device; and sending the third control signal to the first audio device and the fourth control signal to the second audio device.
Q. The one or more computer-readable media of P, wherein the first setting is a volume and a second setting is a balance.
R. The one or more computer-readable media of P or Q, wherein the operations further comprise: receiving a third user input to add a third device to the audio system; causing the third device to perform an initialization test and generate test data associated with the third device; receiving a fourth user to adjust a third setting associated with the audio system; determining, based at least in part on the third user input and the test data, a fifth control signal for configuring the first audio device, a sixth control signal for configuring the second audio device, and a seventh control signal for configuring the third audio device; and sending the fifth control signal to the first audio device, the sixth control signal to the second audio device, and the seventh control signal to the third audio device.
S. The one or more computer-readable media of R, wherein the initialization test includes output sound into a physical environment associated with the audio system and capturing the test data via one or more microphones.
T. The one or more computer-readable media of P-S, wherein the operations further comprise: receiving, first sensor data from the first audio device and second sensor data associated with the second audio device while the audio system is in operation; and responsive to determining, based at least in part on the first sensor data and the second sensor data, that the audio system has met or exceeded a limit indicator, presenting a warning on a display.

While the example clauses described above are described with respect to one particular implementation, it should be understood that, in the context of this document, the content of the example clauses can also be implemented via a method, device, system, a computer-readable medium, and/or another implementation. Additionally, any of examples A-T may be implemented alone or in combination with any other one or more of the examples A-T.

### CONCLUSION

While one or more examples of the techniques described herein have been described, various alterations, additions, permutations and equivalents thereof are included within the scope of the techniques described herein. As can be understood, the components discussed herein are described as divided for illustrative purposes. However, the operations performed by the various components can be combined or performed in any other component. It should also be understood that components or steps discussed with respect to one example or implementation may be used in conjunction with components or steps of other examples.

In the description of examples, reference is made to the accompanying drawings that form a part hereof, which show by way of illustration specific examples of the claimed subject matter. It is to be understood that other examples can be used and that changes or alterations, such as structural changes, can be made. Such examples, changes or alterations are not necessarily departures from the scope with respect to the intended claimed subject matter. While the steps herein may be presented in a certain order, in some cases the ordering may be changed so that certain inputs are provided at different times or in a different order without changing the function of the systems and methods described. The disclosed procedures could also be executed in different orders. Additionally, various computations that are herein need not be performed in the order disclosed, and other examples using alternative orderings of the computations could be readily implemented. In addition to being reordered, the computations could also be decomposed into sub-computations with the same results.

What is claimed is:

1. A method comprising:
presenting, on a display of a user equipment and to a user, a user interface associated with an audio system comprising two or more audio devices within a physical environment;
receiving, via the user interface, a user input to adjust a setting associated the audio system;
determining, based at least in part on the user input and first sensor data associated with a first audio device of the two or more audio devices, a first control signal for configuring the first audio device;
determining, based at least in part on the user input and second sensor data associated with a first audio device of the two or more audio devices, a second control signal for configuring the second audio device, the second control signal different than the first control signal; and
sending the first control signal to the first audio device and the second control signal to the second audio device.

2. The method of claim 1, wherein determining the first control signal is based at least in part on the second sensor data and determining the second control signal is based at least in part on the first sensor data.

3. The method of claim 1, wherein determining the first control signal is based at least in part on third-party data associated with operations of the first audio device.

4. The method of claim 1, further comprising:
determining, based at least in part on the first sensor data and the second sensor data, a first operational threshold and a second operational threshold associated with the audio system, the second operational threshold different than the first operational threshold; and
presenting the first operation threshold and the second operational threshold on the display of the user equipment.

5. The method of claim 4, wherein the first operational threshold is a continuous play threshold and the second operational threshold is a recommended operational limit of the audio system.

6. The method of claim 4, wherein presenting the first operation threshold and the second operational threshold on the display of the user equipment further comprises presenting a user input control, a current operational status indictor, a first limit indicator associated with the first operation threshold, and a second limit indicator associated with the first operation threshold on the display of the user equipment.

7. The method of claim 4, further comprising:
receiving, third sensor data from the first audio device while the first audio device and the second audio device are operating; and
responsive to determining, based at least in part on the third sensor data, that the audio system has met or exceeded the first operational threshold, presenting a warning message on the display of the user equipment.

8. The method of claim 7, wherein the warning message is associated with at least one of the following:
a temperature;
an electrical current;
an amperage;
a Class bias; or
a period of time.

9. A remote-control system comprising:
one or more processors; and
one or more computer-readable media storing instructions that, when executed by the one or more processors, cause the remote-control system to perform operations comprising:
presenting, on a display, a user interface including a first section associated with a first audio device of an audio system and a second section associated with a second audio device of the audio system, a first user input control, a first limit indicator, and a second limit indictor, the first limit indicator associated with a first operational threshold of the first audio device or the second audio device and the second limit indicator associated with a second operational threshold of first audio device or the second audio device;
receiving, via the first user input control, a first user input to adjust a first setting associated with the audio system;
determining, based at least in part on the first user input, a first control signal for configuring the first audio device and a second control signal different than the first control signal for configuring the second audio device; and
sending the first control signal to the first audio device and the second control signal to the second audio device.

10. The system of claim 9, wherein the first limit indicator is a continuous play threshold and the second limit indicator is a recommended operational limit of the audio system.

11. The system of claim 9, wherein the operations further comprise:
responsive to receiving a second user input to transition from the first section to the second section, presenting on the display a second user input control, the first limit indicator, and the second limit indictor;
receiving, via the second user input control, a third user input to adjust a second setting associated with the audio system;
determining, based at least in part on the user input, a third control signal for configuring the first audio device and a fourth control signal different than the first control signal for configuring the second audio device; and
sending the third control signal to the first audio device and the fourth control signal to the second audio device.

12. The system of claim 11, wherein the first setting is a volume and the second setting is an electrical current.

13. The system of claim 9, wherein the operations further comprise:
receiving, first sensor data from the first audio device and second sensor data associated with the second audio device while the audio system is in operation; and
responsive to determining, based at least in part on the first sensor data and the second sensor data, that the audio system has met or exceeded first limit indicator, presenting a first warning on the display.

14. The system of claim 13, wherein the operations further comprise:
responsive to determining, based at least in part on the first sensor data and the second sensor data, that the audio system has met or exceeded second limit indicator, presenting a second warning on the display.

15. The system of claim 13, wherein the first warning is an icon and the second warning is a message.

16. One or more computer-readable media storing instructions that, when executed by one or more processors, cause the one or more processors to perform operations comprising:
receiving, via a first user input control associated with a first audio device of an audio system, a first user input to adjust a first setting associated with the audio system;
determining, based at least in part on the first user input, a first control signal for configuring the first audio device and a second control signal different than the first control signal for configuring a second audio device of the audio system;
sending the first control signal to the first audio device and the second control signal to the second audio device;
receiving, via a second user input control associated with the second audio device, a second user input to adjust a second setting associated with the audio system;
determining, based at least in part on the second user input, a third control signal for configuring the first audio device and a fourth control signal different than the first control signal for configuring the second audio device; and
sending the third control signal to the first audio device and the fourth control signal to the second audio device.

17. The one or more computer-readable media of claim 16, wherein the first setting is a volume and a second setting is a balance.

18. The one or more computer-readable media of claim 16, wherein the operations further comprise:
receiving a third user input to add a third device to the audio system;
causing the third device to perform an initialization test and generate test data associated with the third device;
receiving a fourth user to adjust a third setting associated with the audio system;
determining, based at least in part on the third user input and the test data, a fifth control signal for configuring the first audio device, a sixth control signal for configuring the second audio device, and a seventh control signal for configuring the third audio device; and
sending the fifth control signal to the first audio device, the sixth control signal to the second audio device, and the seventh control signal to the third audio device.

19. The one or more computer-readable media of claim 18, wherein the initialization test includes output sound into a physical environment associated with the audio system and capturing the test data via one or more microphones.

20. The one or more computer-readable media of claim 16, wherein the operations further comprise:
receiving, first sensor data from the first audio device and second sensor data associated with the second audio device while the audio system is in operation; and
responsive to determining, based at least in part on the first sensor data and the second sensor data, that the audio system has met or exceeded a limit indicator, presenting a warning on a display.
